(19) United States
(12) Patent Application Publication
(10) Pub. No.: US 2024/0191015 A1
(43) Pub. Date: Jun. 13, 2024

(54) COPOLYMER

(71) Applicant: BOREALIS AG, Vienna (AT)

(72) Inventors: Luigi Maria Cristoforo RESCONI, Linz (AT); Wilfried Peter TÖLTSCH, Linz (AT); Gerhard HUBNER, Linz (AT); Andreas ALBRECHT, Linz (AT); Ljiljana JEREMIC, Linz (AT)

(21) Appl. No.: 18/283,915

(22) PCT Filed: Mar. 24, 2022
(86) PCT No.: PCT/EP2022/057847

§ 371 Date: Sep. 25, 2023

(30) Foreign Application Priority Data
Mar. 24, 2021 (EP) 21164709.4

(51) Int. Cl. C08F 255/04; C08F 2/00; C08F 4/76

(52) U.S. Cl. CPC C08F 255/04; C08F 2/001; C08F 4/76

(57) ABSTRACT

The invention relates to an amorphous ethylene-propylene copolymer with an intrinsic viscosity (iV) measured in decalin at 135° C. of at least 2.0 and having at least one of the following properties: (i) more than 1 internal vinylidene unsaturation per chain; and (ii) more than 2 long chain branches per chain.

The present invention relates to a heterophasic propylene resin comprising an amorphous ethylene propylene copolymer with unique properties and articles comprising said resins or copolymers. In a further embodiment, the invention relates to a process for producing a heterophasic propylene resin using a metallocene catalyst in a multistage polymerisation process. In particular, the invention relates to a process wherein the chemical and physical properties of the rubber phase of the heterophasic propylene resin can be controlled. This is achieved through the use of a gas phase reactor, operating at a particular temperature, to produce said rubber phase.

### BACKGROUND

Multistage polymerisation processes are well known and widely used in the art for producing polypropylene. Process configurations containing at least one slurry phase polymerisation reactor and at least one gas phase polymerisation reactor are disclosed e.g. in U.S. Pat. No. 4,740,550, and further e.g. in WO98/058975 and WO98/058976. A prepolymerisation reactor is often included in the process configuration, typically to maximise catalyst performance.

Single site catalysts have been used to manufacture polyolefins for many years. Countless academic and patent publications describe the use of these catalysts in olefin polymerisation. One big group of single site catalysts are metallocenes, which are nowadays used industrially and polyethylenes and polypropylenes in particular are often produced using cyclopentadienyl based catalyst systems with different substitution patterns.

Single site catalysts such as metallocenes are used in propylene polymerisation in order to achieve some desired polymer properties. However, there are some problems in using metallocenes on an industrial scale in multistage polymerisation configurations. Thus, there is room for improving the process and catalyst behaviour in the process.

As discussed, the multistage polymerisation of propylene often takes place using at least one slurry phase polymerisation reactor and at least one gas phase polymerisation reactor. In the context of a heterophasic polypropylene resin, which comprises a propylene homopolymer matrix (or a propylene copolymer matrix with a low comonomer content, i.e. a random propylene copolymer) and a propylene ethylene (or propylene-ethylene-alpha-olefin terpolymer) rubber component which is typically dispersed within the matrix, the rubber component is usually produced in the gas phase reactor (GPR). Examples of such processes are disclosed in WO 2018/122134 and WO 2019/179959. However, metallocene catalysts have several limitations when used to produce ethylene-propylene copolymers (EPR) in the gas phase.

One of these limitations is a relatively low ethylene reactivity relative to propylene (the so-called C2/C3 reactivity ratio) in the gas phase, which is typically below 0.5. This means that the C2/C3 gas phase ratio fed to the reactor must be significantly higher than the desired copolymer composition. However, the C2/C3 gas phase ratio feed to the GPR is limited to low values due to pressure limitations in the GPR. For this reason, under usual temperature and pressure conditions, the rubber C2 content is limited upwards when using metallocene catalysts. In addition, the chemical nature of ethylene-propylene rubbers (linear and saturated, therefore anelastic and hydrophobic) limits their application range, especially when elastic recovery (good tension set and compression set), high shock absorption (impact strength) and shape stability (low flow under compression or stretching) are required.

WO2015/139875 discloses a process for the preparation of a heterophasic propylene copolymer (RAHECO) comprising (i) a matrix (M) being a propylene copolymer (R-PP) and (ii) an elastomeric propylene copolymer (EC) dispersed in said matrix (M).

The present inventors have now found a particular set of operating conditions for the gas phase reactor which are able to solve the problems disclosed above. In particular, the invention combines the use of a particular class of metallocene catalysts with a gas phase reactor operating at increased temperature. Surprisingly, this combination allows for several chemical and physical properties of the rubber phase to be controlled, such as unsaturation and long chain branching. This has led to the identification of ethylene-propylene rubbers with unique properties.

### SUMMARY OF INVENTION

Thus, viewed from one aspect the invention provides an amorphous ethylene-propylene copolymer with an intrinsic viscosity (iV) measured in decalin at 135° C. of at least 2.5 and having at least one of the following properties;
(i) more than 1 internal vinylidene unsaturation per chain; and
(ii) more than 2 long chain branches per chain.

Viewed from a further aspect, the invention provides a heterophasic polypropylene resin comprising a polypropylene matrix phase (A) and an ethylene-propylene copolymer phase (B) dispersed within the matrix, wherein the ethylene-propylene copolymer phase (B) is an amorphous ethylene-propylene copolymer as hereinbefore defined.

The invention further provides a process for the preparation of a heterophasic polypropylene resin, in a multistage polymerisation process in the presence of a metallocene catalyst, said process comprising:
(I) in a first polymerisation step, polymerising propylene and optionally at least one C2-10 alpha olefin comonomer; and subsequently
(II) in a second polymerisation step, polymerising propylene, ethylene and optionally at least one C4-10 alpha olefin comonomer, in the presence of the metallocene catalyst and polymer from step (I);
wherein said metallocene catalyst comprises a metallocene complex of Formula I

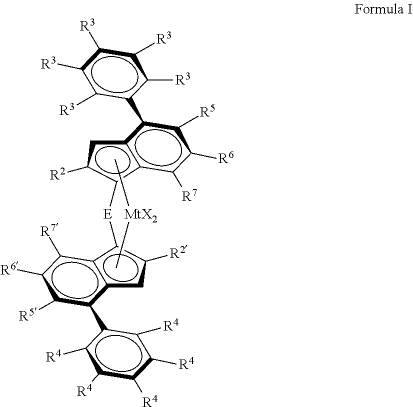

wherein Mt is Zr or Hf;
each X is a sigma-ligand;
E is a —CR¹₂—, —CR¹₂—CR¹₂—, —CR¹₂—SiR¹₂—, —SiR¹₂— or —SiR¹₂—SiR¹₂— group chemically linking the two cyclopentadienyl ligands; the R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,
R² and R^{2′} are the same or different from each other;
R² is a —CH₂R group, with R being H or a linear or branched C₁₋₆ alkyl group, C₃₋₈ cycloalkyl group, C₆₋₁₀ aryl group;
R^{2′} is a C₁₋₂₀ hydrocarbyl group; preferably, R² and R^{2′} are the same and are linear or branched C₁₋₆ alkyl groups;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷=H, then both R⁵, R⁶≠H, and when R^{7′}=H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen; and
wherein step (II) takes place in at least one gas phase reactor operating at a temperature of at least 80° C.

Viewed from another aspect, the invention provides a heterophasic polypropylene resin obtained or obtainable by a process as hereinbefore defined.

Viewed from another aspect the invention provides the use of an amorphous ethylene-propylene copolymer or a heterophasic polypropylene resin as hereinbefore defined in the manufacture of an article, e.g. a flexible tube, pipe, profile, cable insulation, sheet or film.

### Definitions

Throughout the description, the following definitions are employed.

The copolymer of the invention is an amorphous ethylene propylene copolymer. This copolymer may also be termed the “ethylene propylene rubber” or “rubber component”. Furthermore, the terms “amorphous copolymer”, “dispersed phase”, “predominantly amorphous copolymer” and “rubber phase” denote the same, i.e. are interchangeable in the present invention. By “amorphous” we mean a polymer with a randomly ordered molecular structure and one which is non-crystalline. Amorphous further means that the copolymer, when analysed by DSC as a pure component (after having been extracted from the matrix by xylene extraction), has a heat of fusion of less than 20 J/g.

The invention also relates to a heterophasic polypropylene resin comprising the ethylene propylene rubber. The terms “heterophasic polypropylene copolymer” “heterophasic propylene resin” and “heterophasic polypropylene resin” are used interchangeably and are equivalent. By “heterophasic polypropylene resin” we mean a polymer which contains a crystalline or semi-crystalline propylene homopolymer or random propylene copolymer component which is a polypropylene matrix phase (A) and an amorphous ethylene propylene copolymer rubber component (B). The two components are mixed together and the (A) component constitutes the continuous phase and the (B) component is finely dispersed in the (A) component. The rubber component (B) may also be termed the “soluble fraction (SF)” as it is generally soluble in 1,2,4-trichlorobenzene (TCB) and in xylene at 23° C. Furthermore, the term EPR or ethylene propylene rubber/ethylene propylene copolymer is used here in the context of component (B) of the heterophasic polypropylene resin.

### DETAILED DESCRIPTION OF THE INVENTION

The present invention relates to an amorphous ethylene propylene copolymer having an intrinsic viscosity (iV) in a particular range as well as a particular level of long chain branching or unsaturations. The invention further relates to heterophasic polypropylene resins containing said copolymers and a process for the preparation of such heterophasic polypropylene resins.

### Amorphous Ethylene Propylene Copolymer

The amorphous ethylene propylene copolymer of the invention is a copolymer comprising ethylene and propylene. The ethylene propylene copolymer is soluble in 1,2,4-trichlorobenzene (TCB) and in xylene at 23° C.

It is possible for the ethylene propylene copolymer to contain comonomers other than ethylene and propylene such as other for example C₄₋₂₀ olefins, e.g. 1-butene, 1-hexene, 4-methyl-1-pentene, 1-octene etc. Thus, in one embodiment, the EPR component may be an ethylene-propylene-alpha-olefin terpolymer, such as a propylene-ethylene-1-butene copolymer. However, it is preferred if no other comonomers are present.

The ethylene propylene copolymer can be unimodal or multimodal (e.g bimodal) with respect to the molecular weight distribution and/or the comonomer distribution.

In one embodiment, the copolymer is unimodal. More particularly, the copolymer is preferably unimodal with respect to the molecular weight distribution and/or the comonomer distribution.

The ethylene propylene copolymer is preferably an isotactic copolymer.

The ethylene content of the copolymer is preferably at least 15 wt %, more preferably at least 20 wt %, even more preferably at least 21 wt %, such as at least 22 wt %, e.g. at least 24 wt %, relative to the total weight of the copolymer. Suitable ranges for the ethylene content of the copolymer may therefore be 20 to 80 wt %, such as 22 to 75 wt %, ideally 24 to 70 wt %, relative to the total weight of the copolymer.

The intrinsic viscosity (iV) of the ethylene propylene copolymer is at least 2.5 dl/g, preferably at least 3.0 dl/g, when determined in decahydronaphthalene (decalin, DHN) at 135° C. according to DIN EN ISO 1628-1 and -3. Suitable ranges for the intrinsic viscosity (iV) of the copolymer are 2.5 to 7.0 dl/g, preferably 2.5 to 6.5 dl/g, more preferably 2.5 to 6.2 dl/g, especially more preferably 3.0 to 6.0 dl/g when determined according to DIN EN ISO 1628-1 and -3.

The copolymer preferably has an Mw of at least 200,000 Da, more preferably at least 250,000 Da, such as at least 300,000 Da.

A unique feature of the ethylene propylene copolymer of the invention is that, in combination with an intrinsic viscosity (iV) of at least 2.5 dl/g, it has at least one of the following properties:
(i) more than 1 internal vinylidene unsaturation per chain, preferably more than 2 internal vinylidene unsaturations per chain; and
(ii) more than 2 long chain branches per chain, preferably more than 3 long chain branches per chain.

In a particularly preferred embodiment, the ethylene propylene copolymer has both properties (i) and (ii) defined above.

The number of internal vinylidene unsaturations per chain and the number of long chain branches per chain can be determined by ¹H NMR by the process described under the heading “Quantification of Internal Vinylidene Unsaturations” in the “Measurement Methods” section. The reported long chain branches per chain values in the context of this invention always refer to the number of long chain branches per chain of the high molecular weight fraction (85-100 wt % of cumulative weight fraction), as described under the heading “Branching Calculation g′(85-100% cum)” in the “Measurement methods” section.

The ethylene propylene copolymer may be prepared by any suitable method. Typically, however, it is made in at least one gas phase reactor operating at a temperature of at least 80° C.

### Heterophasic Polypropylene Resin

The heterophasic polypropylene resin of the invention (HECO) comprises a crystalline or semi-crystalline propylene homopolymer or random propylene copolymer component, which is the polypropylene matrix phase (A), in which an amorphous propylene-ethylene copolymer (B) is dispersed (rubber phase, such as EPR).

Thus, the polypropylene matrix phase (A) contains (finely) dispersed inclusions being not part of the matrix and said inclusions contain the amorphous copolymer (B).

The term “heterophasic polypropylene resin” used herein denotes copolymers comprising a matrix resin, being a polypropylene homopolymer or a propylene copolymer and a predominantly amorphous copolymer (B) dispersed in said matrix resin, as defined in more detail below.

In the present invention, the term “matrix” is to be interpreted in its commonly accepted meaning, i.e. it refers to a continuous phase (in the present invention a continuous polymer phase) in which isolated or discrete particles such as rubber particles may be dispersed. The propylene polymer is present in such an amount that it forms a continuous phase which can act as a matrix.

The resins of the invention preferably comprise an isotactic propylene matrix component (A). Component (A) may consist of a single propylene polymer but (A) may also comprise a mixture of different propylene polymers. The same applies for component (B): it may consist of a single polymer, but may also comprise a mixture of different EPR's.

In a preferred embodiment therefore, the resin consists essentially of components (A) and (B). The “consists essentially of” wording is used herein to indicate the absence of other polyolefinic components. It will be appreciated that polymers contain additives and these may be present.

The heterophasic polypropylene resin according to the present invention is typically produced by sequential polymerization. Preferably, in at least one step the polypropylene matrix phase (A) is produced, and in at least one subsequent step the amorphous propylene-ethylene copolymer (B) is produced in the presence of the polypropylene matrix phase (A).

In order to characterize the matrix phase and the amorphous phase of a heterophasic propylene resin several methods are known.

The crystalline fraction and a soluble fraction may be separated with the CRYSTEX method using 1,2,4-trichlorobenzene (TCB) as solvent. This method is described below in the measurement methods section. In this method, a crystalline fraction (CF) and a soluble fraction (SF) are separated from each other. The crystalline fraction (CF) largely corresponds to the matrix phase and contains only a small part of the amorphous phase, while the soluble fraction (SF) largely corresponds to the amorphous phase and contains only a negligible (e.g. less than 0.5 wt %) part of the matrix phase. Thus, in the context of the present invention, the term “crystalline fraction (CF)” refers to component (A) and “soluble fraction (SF)” refers to component (B).

It is required that the polypropylene matrix phase (A) is at least partially crystalline thus ensuring that the resin as a whole comprises a crystalline phase and an amorphous phase.

It is preferred that the heterophasic polypropylene resin has a melting point (Tm) of 100 to 165° C., preferably 110 to 165° C., especially 120 to 165° C.

It is preferred if the heterophasic polypropylene resin has an MFR₂ (melt flow rate measured according to ISO1133 at 230° C. with 2.16 kg load) of 0.1 to 200 g/10 min, more preferably 1.0 to 100 g/10 min, such as 2.0 to 50 g/10 min.

It is preferred if the heterophasic polypropylene resin has an Mw/Mn of 2.0 to 5.0, such as 2.5 to 4.5.

Preferably there is at least 40 wt % of component (A) present in the heterophasic polypropylene resins of the invention, such as 45 to 90 wt %, more preferably 50 wt % to 85 wt % relative to the total weight of the heterophasic polypropylene resin.

Alternatively viewed, there should ideally be at least 40 wt % of a crystalline fraction present in the heterophasic polypropylene resins of the invention, such as 45 to 90 wt %, more preferably 50 wt % to 85 wt % of a crystalline fraction relative to the total weight of the heterophasic polypropylene resin.

There is preferably at least 10 wt % of the EPR (B) fraction present and preferably less than 60 wt % of component (B). Amounts of component (B) are preferably in the range of 10 to 55 wt %, ideally 15 to 50 wt % relative to the total weight of the heterophasic polypropylene resin.

Alternatively viewed, the soluble fraction (SF) of the heterophasic resin of the invention is preferably from 10 to less 60 wt %, such as 10 to 55 wt %, ideally 15 to 50 wt % relative to the total weight of the heterophasic polypropylene resin.

It will be appreciated that the amount of soluble fraction should essentially be the same as the amount of component (B) present as component (A) should contain almost no soluble components. Component (B) on the other hand is completely soluble.

It is also a preferred feature of the invention that the intrinsic viscosity (iV) of the SF of the resin is larger than the intrinsic viscosity (iV) of the CF of the resin. Intrinsic viscosity (iV) is a measure of molecular weight and thus the SF of the resin can be considered to have a higher Mw (weight average molecular weight) than the CF

The iV of the polymer as a whole may be 0.9 to 4 dl/g, preferably in the range of 1.0 to 3 dl/g.

### Polypropylene Matrix Phase (A)

The polypropylene matrix phase (A) of the heterophasic polypropylene resin is at least partially crystalline. The matrix therefore may be a crystalline or semi-crystalline propylene homopolymer or random propylene copolymer component, or a combination thereof. The term “semicrystalline” indicates that the copolymer has a well-defined melting point and a heat of fusion higher than 50 J/g when analysed by DSC as a pure component. It is preferred if the matrix phase is at least partially crystalline thus ensuring that the polymer as a whole comprises a crystalline phase and an amorphous phase.

In one embodiment the polypropylene matrix phase (A) comprises a homopolymer of propylene as defined below, preferably consists of a homopolymer of propylene as defined below. The expression “homopolymer” used in the instant invention relates to a polypropylene that consists substantially of propylene units. In a preferred embodiment, only propylene units in the propylene homopolymer are detectable.

The homopolymer of propylene is isotactic polypropylene, with an isotactic pentad content higher than 90%, more preferably higher than 95%, even more preferably higher than 98%. The homopolymer of propylene contains regiodefects (2,1-inserted units) between 0.01 and 1.5%, more preferably between 0.01 and 1.0%.

The polypropylene homopolymer may comprise or consist of a single polypropylene homopolymer fraction (=unimodal), but may also comprise a mixture of different polypropylene homopolymer fractions.

In cases where the polypropylene homopolymer comprises different fractions, the polypropylene homopolymer is understood to be bi- or multimodal. These fractions may have different average molecular weight or different molecular weight distribution.

It is preferred that the polypropylene homopolymer can be bimodal or multimodal with respect to molecular weight or molecular weight distribution.

It is alternatively preferred that the polypropylene homopolymer can be unimodal with respect to average molecular weight and/or molecular weight distribution.

Thus in one embodiment or the present invention the polypropylene matrix phase (A) is unimodal, whereas in another embodiment the polypropylene matrix phase (A) is bimodal and consists of two propylene homopolymer fractions (hPP-1) and (hPP-2).

In another embodiment, the polypropylene matrix phase (A) may be a random propylene copolymer, such as a propylene-ethylene random copolymer or propylene-butene random copolymer or a propylene-ethylene butene random copolymer or a combination thereof.

When an ethylene comonomer is present in the polypropylene matrix phase (insoluble fraction) component, its content can be up to 5 mol %, or 3.4 wt %, relative to the polypropylene matrix phase as a whole, while when butene comonomer is present, then its content can be up to 5 mol %, or 6.6 wt %, relative to the polypropylene matrix phase as a whole, provided that their combined content is at most 5 mol % relative to the polypropylene matrix phase as a whole. Even more preferably there is less than 2 wt % ethylene in the polypropylene matrix phase, relative to the total weight of the polypropylene matrix phase. It is therefore preferred if the ethylene content of the insoluble fraction of the polymers of the invention is 2 wt % or less, ideally 1.5 wt % or less, relative to the total weight of the polypropylene matrix phase (the total weight of the insoluble fraction). Even more preferably there is less than 1 wt % ethylene in the insoluble fraction (C2(IF)<1 wt %) relative to the total weight of the polypropylene matrix phase (the total weight of the insoluble fraction).

In a further embodiment, the polypropylene matrix phase (A) is bimodal and consists of one homopolymer fraction and one copolymer fraction.

It is preferred that the polypropylene matrix phase has a melting point (Tm) of 100 to 165° C., preferably 110 to 165° C., especially 120 to 165° C.

The MFR₂ of the polypropylene matrix phase (A) may be in the range of 0.1 to 200 g/10 min, such 1 to 150 g/10 min, preferably 2 to 100 g/10 min. Its intrinsic viscosity (iV) is ideally 1 to 4 dl/g.

### Rubber Component (B)

The second component of the heterophasic polypropylene resin is the rubber component (B) i.e. the ethylene-propylene copolymer phase, which is an amorphous copolymer of propylene and ethylene. Thus, the second component is an amorphous copolymer, which is dispersed in the polypropylene matrix phase (A).

As stated above, the terms “soluble fraction”, “amorphous (propylene-ethylene) copolymer”, “dispersed phase” and “rubber phase” denote the same, i.e. are interchangeable in view of this invention.

The rubber phase which forms component (B) of the heterophasic polypropylene resin of the invention may be defined as above for the amorphous propylene-ethylene copolymer of the invention.

### Polymerisation

The present invention also relates to a multistage polymerisation process using a metallocene catalyst, said process comprising an optional but preferred prepolymerisation step, followed by a first and a second polymerisation step.

Preferably the same catalyst is used in each step and ideally, it is transferred from prepolymerisation to subsequent polymerisation steps in sequence in a well known matter. One preferred process configuration is based on a Borstar® type cascade.

Accordingly, the present process comprises
(I) in a first polymerisation step, polymerising propylene and optionally at least one C2-10 alpha olefin comonomer; and subsequently
(II) in a second polymerisation step, polymerising propylene, ethylene and optionally at least one C4-10 alpha olefin comonomer, in the presence of the metallocene catalyst and polymer from step (I);
wherein said metallocene catalyst comprises a metallocene complex as discussed herein, and wherein step (II) takes place in at least one gas phase reactor operating at a temperature of at least 80° C., wherein the process typically produces a heterophasic polypropylene resin as discussed herein.

Further as an example of the present process, the first polymerisation step (I) produces a polypropylene matrix phase (A) as discussed herein and the second polymerization step (II) produces a rubber component (B) (i.e. the amorphous ethylene propylene copolymer) as discussed herein.

### Prepolymerisation

The process of the invention may utilise an in-line prepolymerisation step. The in-line prepolymerisation step takes place just before the first polymerisation step (I) and may be effected in the presence of hydrogen although the concentration of hydrogen should be low if it is present. The concentration of hydrogen may be from 0 to 1 mol(hydrogen)/kmol(propylene), preferably from 0.001 to 0.1 mol(hydrogen)/kmol(propylene).

The temperature conditions within the prepolymerisation step are ideally kept low such as 0 to 50° C., preferably 5 to 40° C., more preferably 10 to 30° C.

The prepolymerisation stage preferably polymerises propylene monomer only.

The residence time in the prepolymerisation reaction stage is short, typically 5 to 30 min.

The prepolymerisation stage preferably generates less than 5 wt % of the total polymer formed, such as 3 wt % or less.

Prepolymerisation preferably takes place in its own dedicated reactor, ideally in liquid propylene slurry. The prepolymerised catalyst is then transferred over to the first polymerisation step. However, it is also possible, especially in batch processes, that prepolymerisation is carried out in the same reactor as the first polymerisation step.

### First Polymerisation Step (I)—Polypropylene Matrix Phase Production

In the present invention, the first polymerisation step involves polymerising propylene and optionally at least one C2-10 alpha olefin comonomer.

Thus, in one embodiment, the first polymerisation step involves polymerising only propylene, so as to produce a propylene homopolymer.

In another embodiment, the first polymerisation step involves polymerising propylene together with at least one C2-10 alpha olefin. In this embodiment, the comonomer polymerised with the propylene may be ethylene or a C4-10 alpha olefin or a mixture of comonomers might be used such as a mixture of ethylene and a C4-10 α-olefin.

As comonomers to propylene are preferably used ethylene, 1-butene, 1-hexene, 1-octene or any mixtures thereof, preferably ethylene. When ethylene comonomer is present in the polymer produced in the first polymerisation step (I), its content may be up to 5 mol %, or 3.4 wt %, while when butene comonomer is present, then its content can be up to 5 mol %, or 6.6 wt %, provided that their combined content is at most 5 mol %, relative to the polymer as a whole.

The first polymerisation step may take place in any suitable reactor or series of reactors. The first polymerisation step may take place in a slurry polymerisation reactor such as a loop reactor or in a gas phase polymerisation reactor, or a combination thereof.

Where a slurry polymerisation reactor is employed, this is typically effected in at least one loop reactor. Ideally, the polymerisation takes place in bulk, i.e. in a medium of liquid propylene. For slurry reactors in general and in particular for bulk reactors, the reaction temperature will generally be in the range 60 to 100° C., preferably 70 to 85° C. The reactor pressure will generally be in the range 5 to 80 bar (e.g. 20 to 60 bar), and the residence time will generally be in the range 0.1 to 5 hours (e.g. 0.3 to 2 hours). When a gas phase reactor is employed, the reaction temperature will generally be in the range 60 to 120° C., preferably 70 to 85° C. The reactor pressure will generally be in the range 10 to 35 bar (e.g. 15 to30 bar), and the residence time will generally be in the range 0.5 to 5 hours (e.g. 1 to 2 hours).

In a preferred embodiment, the first polymerisation step takes place in a slurry loop reactor connected in cascade to a gas phase reactor. In such scenarios, the polymer produced in the loop reactor is transferred into the first gas phase reactor.

It is preferred if hydrogen is used in the first polymerisation step. The amount of hydrogen employed is typically considerably larger than the amount used in the prepolymerisation stage.

### Second Polymerisation Step (II)—Rubber Phase Production

The second polymerisation step (II) of the process of the invention is a gas polymerisation step in which propylene, ethylene and optionally at least one C4-10 alpha olefin comonomer are polymerised in the presence of the metallocene catalyst and polymer from step (I). This polymerisation step takes place in at least one gas phase reactor. Thus, the second polymerisation step may take place in a single gas phase reactor or more than one gas phase reactor connected in series or parallel.

The C4-10 alpha olefin may be, for example, 1-butene, 1-hexene, 1-octene or any mixtures thereof. Preferably, however, step (II) involves the polymerisation of propylene and ethylene only.

A key feature of the present invention is the reaction temperature in the at least one gas phase reactor of the second polymerisation step. In the process of the invention, the temperature in the gas phase reactor is at least 80° C., preferably at least 85° C. A typical temperature range may be 90 to 120° C., such as 90 to 100° C. Without wishing to be bound by theory, it is considered that increasing the polymerisation temperature in the rubber gas phase reactor (to above 80° C., preferably above 85° C.), while keeping the same total pressure and gas phase composition, not only increases the ethylene reactivity relative to propylene, that is, improving the C2/C3 reactivity ratio, but also has the positive effect of increasing both the internal (vinylidene) unsaturations and the long chain branch (LCB) content of the copolymer produced therein.

The reactor pressure will generally be in the range 10 to 25 bar, preferably 15 to 22 bar. Increasing the gas phase reactor temperature, while keeping the same total pressure and gas phase composition, leads to increased productivity, does not negatively affect the molecular weight of the rubber, and most important, increases the ethylene reactivity relative to propylene, enabling the production of polymers with a broader composition range at a given reactor pressure

The residence time within any gas phase reactor will generally be 0.5 to 8 hours (e.g. 0.5 to 4 hours). The gas used will be the monomer mixture optionally as mixture with a non-reactive gas such as propane.

The hydrogen content within the gas phase reactor(s) is important for controlling polymer properties but is independent of the hydrogen added to prepolymerisation and first polymerisation steps. Hydrogen left in the reactor(s) of step I can be partially vented before a transfer to the gas phase reactor(s) of step II is effected, but it can also be transferred together with the polymer/monomer mixture of step I into the gas phase reactor(s) of step II, where more hydrogen can be added to control the MFR to the desired value.

In a particularly preferred embodiment of the invention, no hydrogen is added during the gas phase polymerisation step II.

The split (by weight) between the first and second polymerisation steps is ideally 55:45 to 85:15, preferably 60:40 to 80:20. Note that any small amount of polymer formed in prepolymerisation is counted as part of the polymer prepared in the first polymerisation step.

### Metallocene Catalyst

The processes of the invention employ a metallocene catalyst. The metallocene complexes are preferably chiral, racemic bridged bisindenyl metallocenes in their anti-configuration. The metallocenes can be symmetric or asymmetric. Symmetric in this context means that the two indenyl ligands forming the metallocene complex are chemically identical, that is they have the same number and type of substituents. Asymmetrical means simply that the two indenyl ligands differ in one or more of their substituents, be it their chemical structure or their position on the indenyl moiety. In the case of asymmetrical metallocene complexes, although they are formally C₁-symmetric, they ideally retain a pseudo-C₂-symmetry since they maintain C₂-symmetry in close proximity of the metal centre although not at the ligand periphery. By nature of their chemistry both anti and syn enantiomer pairs (in case of C₁-symmetric complexes) or a racemic anti and a meso form (in case of C₂-symmetric complexes) are generated during the synthesis of the complexes. For the purpose of this invention, racemic-anti means that the two indenyl ligands are oriented in opposite directions with respect to the cyclopentadienyl-metal-cyclopentadienyl plane, while racemic-syn (or meso form) means that the two indenyl ligands are oriented in the same direction with respect to the cyclopentadienyl-metal-cyclopentadienyl plane, as shown as an example in the scheme below.

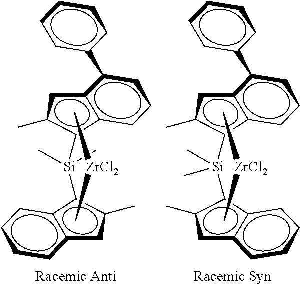

The following formulae are therefore intended to represent the racemic anti isomers of the metallocene complexes.

The metallocene complexes are preferably employed as the racemic-anti-isomers. Ideally, therefore at least 90 mol %, such as at least 95 mol %, especially at least 98 mol % of the metallocene catalyst complex is in the racemic anti-isomeric form.

For the purpose of this invention, the numbering scheme of the indenyl and indacenyl ligands is the following:

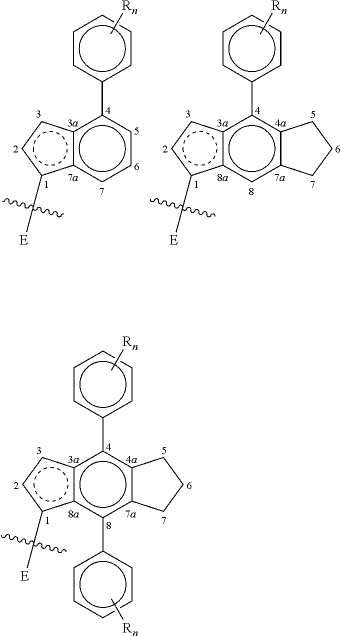

It will be appreciated that in the complexes of the invention, the metal ion Mt is coordinated by ligands X so as to satisfy the valency of the metal ion and to fill its available coordination sites. The nature of these σ-ligands can vary greatly.

The term C₁₋₂₀ hydrocarbyl group includes C₁₋₂₀ alkyl, C₂₋₂₀ alkenyl, C₂₋₂₀ alkynyl, C₃₋₂₀ cycloalkyl, C₃₋₂₀ cycloalkenyl, C₆₋₂₀ aryl groups, C₇₋₂₀ alkylaryl groups or C₇₋₂₀ arylalkyl groups or of course mixtures of these groups such as cycloalkyl substituted by alkyl. Linear and branched hydrocarbyl groups cannot contain cyclic units. Aliphatic hydrocarbyl groups cannot contain aryl rings.

Unless otherwise stated, preferred C₁₋₂₀ hydrocarbyl groups are C₁₋₂₀ alkyl, C₄₋₂₀ cycloalkyl, C₅₋₂₀ cycloalkyl-alkyl groups, C₇₋₂₀ alkylaryl groups, C₇₋₂₀ arylalkyl groups or C₆₋₂₀ aryl groups, especially C₁₋₁₀ alkyl groups, C₆₋₁₀ aryl groups, or C₇₋₁₂ arylalkyl groups, e.g. C₁₋₈ alkyl groups. Most especially preferred hydrocarbyl groups are methyl, ethyl, propyl, isopropyl, tertbutyl, isobutyl, C₅₋₆-cycloalkyl, cyclohexylmethyl, phenyl or benzyl.

The term halogen includes fluoro, chloro, bromo and iodo groups, especially chloro groups.

The metallocenes employed in the invention are bridged bisindenyl metallocenes in their racemic anti configuration, having the structure described by formula I:

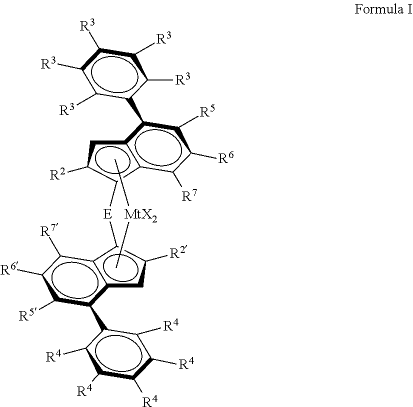

wherein Mt is Zr or Hf;
each X is a sigma-ligand;
E is a —CR¹₂—, —CR¹₂—CR¹₂—, —CR¹₂—SiR¹₂—, —SiR¹₂— or —SiR¹₂—SiR¹₂— group chemically linking the two cyclopentadienyl ligands; The R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷=H, then both R⁵, R⁶≠H, and when R^{7′}=H, then both R^{5′}, R^{6′}≠H, and with the additional proviso that R⁵ and R⁶ can be hydrogen only when R⁷ is different from hydrogen and that R^{5′} and R^{6′} can be hydrogen only when R⁷ is different from hydrogen.

For the above-defined Formula I, the following represent preferable embodiments, which can be selected alone or in combination.

Mt is preferably Zr of Hf.

E is preferably SiMe₂

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

each R⁵, R^{5′}, R⁶ and R^{6′} are independently preferably independently a C₁₋₁₀ hydrocarbyl group, an OY group wherein Y is a C₁₋₆ alkyl group, or —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is preferably H, a C₁₋₂₀ alkyl group or a C₆₋₂₀ aryl group

R^{7′} is preferably H.

Preferably, the metallocenes that are suitable for the invention are bridged bisindenyl metallocenes in their racemic anti configuration, having the structure described by formula II:

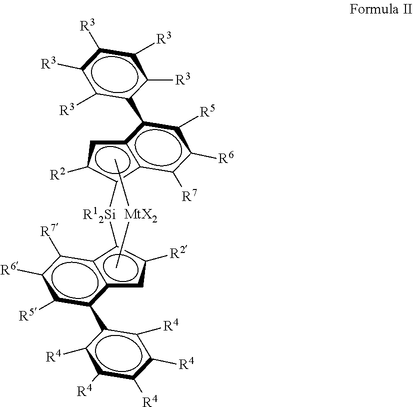

wherein Mt is Zr or Hf;
X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
The two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷=H, then both R⁵, R⁶≠H, and when R^{7′}=H, then both R^{5′}, R^{6′}≠H, and with the additional proviso that R⁵ and R⁶ can be hydrogen only when R⁷ is different from hydrogen and that R^{5′} and R^{6′} can be hydrogen only when R⁷ is different from hydrogen;

For the above-defined Formula II, the following represent preferable embodiments, which can be selected alone or in combination.

Mt is preferably Zr or Hf.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

each R⁵, R^{5′}, R⁶ and R^{6′} are independently preferably a C₁₋₁₀ hydrocarbyl group, an OY group wherein Y is a C₁₋₆ alkyl group, or —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is preferably H, a C₁₋₂₀ alkyl group or a C₆₋₂₀ aryl group

R^{7′} is preferably H.

Even more preferably, the metallocenes that are suitable for the invention are bridged bisindenyl metallocenes in their racemic anti configuration, having the structure described by formula III:

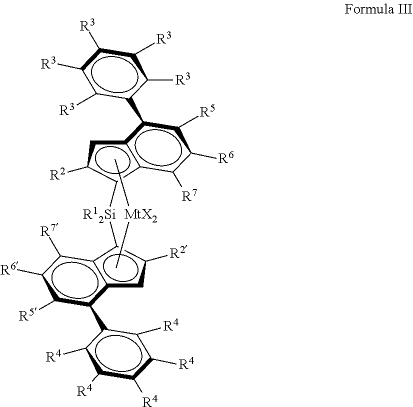

wherein Mt is Zr or Hf;
X, which can be the same or different from each other, are halogen, hydrogen, C₁₋₆ hydrocarbyl groups, or OY or NY₂ groups wherein Y is a C₁₋₆ hydrocarbyl group optionally containing 1 silicon atom;
the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁-C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ is H or an OY group or a C₁₋₂₀ hydrocarbyl group optionally containing up to two silicon, oxygen, sulphur or nitrogen atoms, with the proviso that when R⁷=H, then both R⁵, R⁶≠H, and with the additional proviso that R⁵ and R⁶ can be hydrogen only when R⁷ is different from hydrogen.

For the above-defined Formula III, the following represent preferable embodiments, which can be selected alone or in combination.

Mt is preferably Zr.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl. each R⁵, R^{5′}, R⁶ and R^{6′} are independently preferably a C₁₋₁₀ hydrocarbyl group, an OY group wherein Y is a C₁₋₆ alkyl group, or —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is preferably H, a C₁₋₂₀ alkyl group or a C₆₋₂₀ aryl group

In one embodiment, the metallocenes that are suitable for the invention are bridged bisindenyl metallocenes in their racemic anti configuration, having the structure described by formula IV:

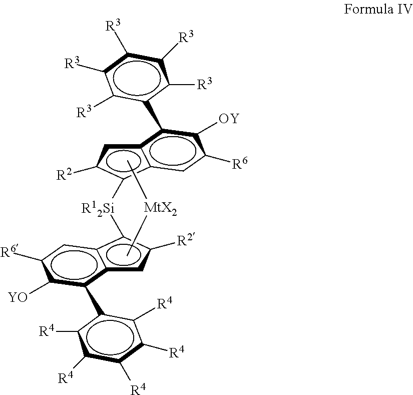

wherein Mt is Zr or Hf;
X, which can be the same or different from each other, are halogen, C₁₋₆ hydrocarbyl groups, or OY or NY₂ groups wherein Y is a C₁₋₆ hydrocarbyl group optionally containing 1 silicon atom;
the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl; most preferably, R¹ are the same and are Me;
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁-C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁶ and R^{6′} are independently a C₁₋₂₀ hydrocarbyl group, optionally containing up to 2 silicon, oxygen, sulphur or nitrogen atoms; and
Y is a C₁₋₁₀ hydrocarbyl group.

For the above-defined Formula IV, the following represent preferable embodiments, which can be selected alone or in combination.

Mt is preferably Zr.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl,

Y is preferably a C₁₋₆ alkyl group, more preferably methyl.

each R⁶ and R^{6′} are independently preferably a C1-10 hydrocarbyl group.

In the same embodiment, more preferably the metallocenes have the structure described by formula V:

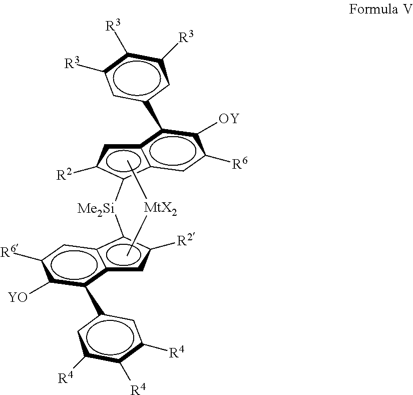

wherein Mt is Zr or Hf;
X, which can be the same or different from each other, are halogen, C₁₋₆ hydrocarbyl groups, or OY or NY₂ groups wherein Y is a C₁₋₆ hydrocarbyl group optionally containing 1 silicon atom;
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁-C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁶ and R^{6′} are independently a C₁₋₁₀ hydrocarbyl group; and
Y is a C₁₋₁₀ hydrocarbyl group.

For the above-defined Formula V, the following represent preferable embodiments, which can be selected alone or in combination.

Mt is preferably Zr.

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl,

Y is preferably a C₁₋₆ alkyl group, more preferably methyl.

each R⁶ and R^{6′} are independently preferably a C₁₋₁₀ hydrocarbyl group.

In the same embodiment, even more preferably the metallocenes have the structure described by formula VI:

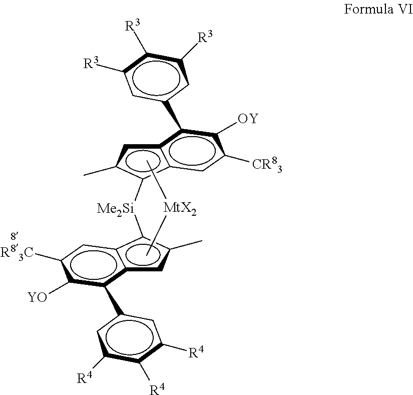

wherein Mt is Zr or Hf;
X, which can be the same or different from each other, are halogen, C₁₋₆ hydrocarbyl groups, or OY or NY₂ groups wherein Y is a C₁₋₆ hydrocarbyl group optionally containing 1 silicon atom;
each R³ and R⁴ are independently the same or can be different and are hydrogen, a linear or branched C₁-C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
R⁵ and R^{5′} are independently a C₁₋₁₀ hydrocarbyl group;
R⁸ and R^{8′} are independently H or a C₁₋₁₀ hydrocarbyl group; and
Y is a C₁₋₁₀ hydrocarbyl group.

For the above-defined Formula VI, the following represent preferable embodiments, which can be selected alone or in combination.

Mt is preferably Zr.

X is preferably halogen, more preferably Cl.

R³ and R⁴ are, independently, preferably H or a linear or branched C₁₋₆ alkyl group, more preferably selected from the group consisting of H, t-butyl and methyl,

Y is preferably is a C₁₋₆ alkyl group, more preferably methyl.

each R⁸ and R^{8′} are independently preferably a C₁₋₁₀ hydrocarbyl group.

Preferred metallocenes in this embodiment are:
rac-dimethylsilanediylbis(2-methyl-4-phenyl-5-methoxy-6-tert-butylinden-1-yl) zirconium dichloride
rac-dimethylsilanediylbis(2-methyl-4-(4′-tert-butylphenyl)-5-methoxy-6-tert-butylinden-1-yl) zirconium dichloride
rac-dimethylsilanediylbis(2-methyl-4-(3′,5′-di-methyl phenyl)-5-methoxy-6-tert-butylinden-1-yl) zirconium dichloride
rac-dimethylsilanediylbis(2-methyl-4-(3′,5′-di-tert-butylphenyl)-5-methoxy-6-tert-butylinden-1-yl) zirconium dichloride
and their hafnium analogues

In a second embodiment, the metallocenes that are suitable for the invention are bridged bisindenyl metallocenes in their racemic anti configuration, having the structure described by formula VII:

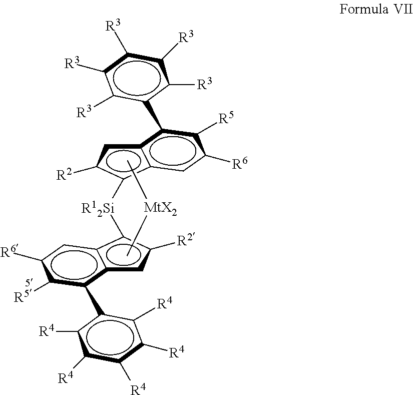

wherein Mt is Zr or Hf;
X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand.

For the above-defined Formula VII, the following represent preferable embodiments, which can be selected alone or in combination.

Mt is preferably Zr or Hf.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

each R⁵, R^{5′}, R⁶ and R^{6′} are independently preferably —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand.

In this second embodiment, the metallocenes have more preferably the structure described by formula VIII:

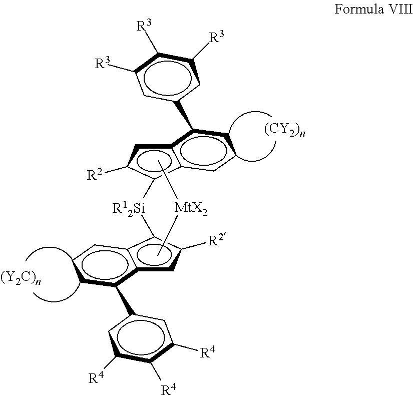

wherein Mt is Zr or Hf;
X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
Y is a C₁₋₁₀ hydrocarbyl group and n is an integer between 2 and 5.

For the above-defined Formula VIII, the following represent preferable embodiments, which can be selected alone or in combination.

Mt is preferably Zr or Hf.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

Y is a C₁₋₁₀ hydrocarbyl group and n is an integer between 3 and 4.

In this second embodiment, the metallocenes have even more preferably the structure described by formula IX:

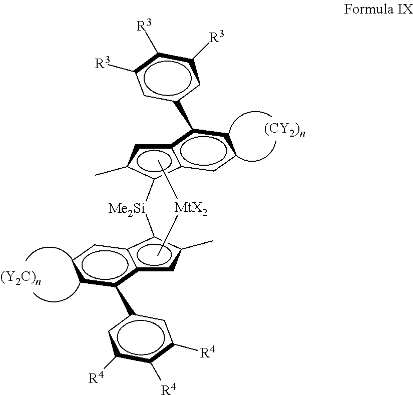

wherein Mt is Zr or Hf;
X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms; most preferably X is chloro or methyl;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
Y is a C₁₋₁₀ hydrocarbyl group and n is an integer between 3 and 4.

For the above-defined Formula IX, the following represent preferable embodiments, which can be selected alone or in combination.

Mt is preferably Zr.

X is preferably halogen, more preferably Cl.

R³ and R⁴ are, independently, preferably H or a linear or branched C₁₋₆ alkyl group, more preferably selected from the group consisting of H, t-butyl and methyl.

Y is a C₁₋₁₀ hydrocarbyl group and n is an integer between 3 and 4.

Preferred metallocenes in this embodiment are:
rac-dimethylsilanediylbis[2-methyl-4-phenyl-1,5,6,7-tetrahydro-s-indacen-1-yl] zirconium dichloride
rac-dimethylsilanediylbis[2-methyl-4-(4-tert-butylphenyl)-1,5,6,7-tetrahydro-s-indacen-1-yl] zirconium dichloride
rac-dimethylsilanediylbis[2-methyl-4-(3,5-dimethylphenyl)-1,5,6, 7-tetrahydro-s-indacen-1-yl] zirconium dichloride
rac-dimethylsilanediylbis[2-methyl-4-(3′,5′-di-tert-butylphenyl)-1,5,6, 7-tetrahydro-s-indacen-1-yl] zirconium dichloride
and their hafnium analogues

In a third embodiment, the metallocenes that are suitable for the invention are asymmetric bridged bisindenyl metallocenes in their racemic anti configuration, having the structure described by formula X:

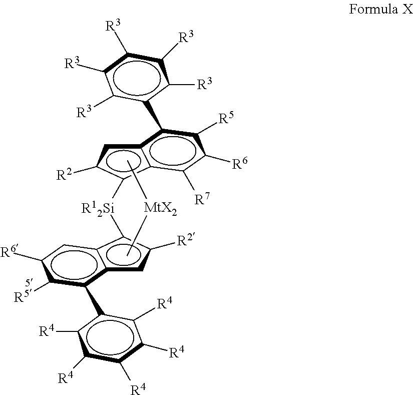

wherein Mt is Zr or Hf;
X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
R⁵, R⁶ are independently hydrogen or a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 of the corresponding indenyl ligand;
R^{5′}, R^{6′} are a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group;
R⁷ is a C₁₋₂₀ hydrocarbyl group optionally containing up to two silicon, oxygen, sulphur or nitrogen atoms.

For the above-defined Formula X, the following represent preferable embodiments, which can be selected alone or in combination.

Mt is preferably Zr or Hf.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

each R⁵, R^{5′}, R⁶ and R^{6′} are independently preferably a C₁₋₁₀ hydrocarbyl group, an OY group wherein Y is a C₁₋₆ alkyl group, or —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;

R⁷ is preferably a C₆₋₂₀ aryl group.

More preferably, the metallocenes of this third embodiment are asymmetric bridged bisindenyl metallocenes in their racemic anti configuration, having the structure described by formula XI:

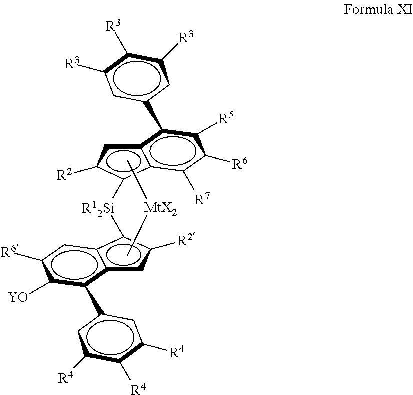

wherein Mt is Zr or Hf;
X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other;
R² and R^{2′} are the same or different from each other, and are a —CH₂R group, with R being H or a linear or branched C₁₋₆ alkyl group, C₃₋₈ cycloalkyl group, C₆₋₁₀ aryl group;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
R⁵, R⁶ are independently hydrogen or a C₁₋₂₀ hydrocarbyl group, optionally containing up to 2 silicon, oxygen, sulphur or nitrogen atoms, and can be —CH═, —CY═, —CH₂—, —CHY— or —CY₂— groups that are part of a cyclic structure of 4 to 7 atoms, including the carbon atoms at positions 5 and 6 of the corresponding indenyl ligand;
R^{5′}, R^{6′} are a C₁₋₂₀ hydrocarbyl group;
⁷ is a C₁₋₂₀ hydrocarbyl group optionally containing up to two silicon, oxygen, sulphur or nitrogen atoms; and
Y is a C₁₋₁₀ hydrocarbyl group.

For the above-defined Formula XI, the following represent preferable embodiments, which can be selected alone or in combination.

Mt is preferably Zr or Hf.

R¹ is preferably methyl

X is preferably halogen, more preferably Cl.

R² and R^{2′} are preferably C₁₋₆ alkyl, more preferably methyl

R³ and R⁴ are, independently, preferably H or a linear or branched C₁₋₆ alkyl group, more preferably selected from the group consisting of H, t-butyl and methyl.

each R⁵ and R⁶ are independently preferably —CH═, —CY═, —CH₂—, —CHY— or —CY₂— groups that are part of a cyclic structure of 4 to 7 atoms, including the carbon atoms at positions 5 and 6 of the corresponding indenyl ligand;

R^{6′} is preferably a C₁₋₁₀ hydrocarbyl group,

R⁷ is preferably a C₆₋₂₀ aryl group;

Y is preferably a C₁₋₆ hydrocarbyl group.

Even more preferably, the metallocenes of this third embodiment are asymmetric bridged bisindenyl metallocenes in their racemic anti configuration, having the structure described by formula XII:

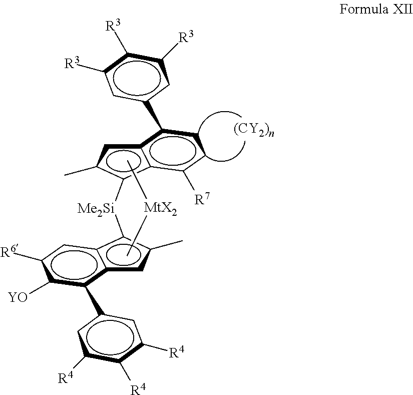

wherein Mt is Zr or Hf;
X, which can be the same or different from each other, are halogen, C₁₋₆ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
R^{5′}, R^{6′} are a C₁₋₂₀ hydrocarbyl group;
Y is a C₁₋₁₀ hydrocarbyl group and n is an integer between 3 and 4.

For the above-defined Formula XII, the following represent preferable embodiments, which can be selected alone or in combination.

Mt is preferably Zr or Hf.

X is preferably halogen, more preferably Cl.

R³ and R⁴ are, independently, preferably H or a linear or branched C₁₋₆ alkyl group, more preferably selected from the group consisting of H, t-butyl and methyl.

Y is a C₁₋₆ hydrocarbyl group and n is 3.

R^{6′} is preferably a C₁₋₁₀ hydrocarbyl group,

R⁷ is preferably a C₆₋₂₀ aryl group.

Most preferably, the metallocenes of this third embodiment are asymmetric bridged bisindenyl metallocenes in their racemic anti configuration, having the structure described by formula XIII:

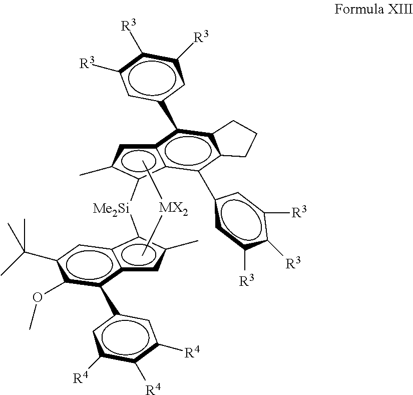

wherein Mt is Zr or Hf;
X, which can be the same or different from each other, are halogen, C₁₋₆ hydrocarbyl groups, or OY or NY₂ groups wherein Y is a C₁₋₁₀ hydrocarbyl group optionally containing up to 2 silicon atoms; most preferably X is chloro or methyl;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded.

For the above-defined Formula XIII, the following represent preferable embodiments, which can be selected alone or in combination.

Mt is preferably Zr or Hf.

X is preferably halogen, more preferably Cl.

R³ and R⁴ are, independently, preferably H or a linear or branched C₁₋₆ alkyl group, more preferably selected from the group consisting of H, t-butyl and methyl.

Preferred metallocenes in this embodiment are:
rac-anti-dimethylsilanediyl[2-methyl-4,8-bis(4′-tert-butylphenyl)-1,5,6,7-tetrahydro-s-indacen-1-yl][2-methyl-4-(3′,5′-dimethylphenyl)-5-methoxy-6-tert-butylinden-1-yl]zirconium dichloride
rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]zirconium dichloride
rac-anti-dimethylsilanediyl[2-methyl-4,8-bis(3′,5′-dimethyl phenyl)-1,5,6,7-tetrahydro-s-indacen-1-yl][2-methyl-4-(3′,5′-di-tert-butylphenyl)-5-methoxy-6-tert-butylinden-1-yl]zirconium dichloride
rac-anti-dimethylsilanediyl[2-methyl-4,8-bis(4′-tert-butylphenyl)-1,5,6,7-tetrahydro-s-indacen-1-yl][2-methyl-4-(4′-tert-butylphenyl)-5-methoxy-6-tert-butylinden-1-yl]zirconium dichloride
rac-anti-dimethylsilanediyl[2-methyl-4,8-bis(4′-tert-butylphenyl)-1,5,6,7-tetrahydro-s-indacen-1-yl][2-methyl-4-(3′,5′-di-tert-butylphenyl)-5-methoxy-6-tert-butylinden-1-yl]zirconium dichloride
and their hafnium analogues.

For the avoidance of doubt, any narrower definition of a substituent offered above can be combined with any other broad or narrowed definition of any other substituent.

Throughout the disclosure above, where a narrower definition of a substituent is presented, that narrower definition is deemed disclosed in conjunction with all broader and narrower definitions of other substituents in the application.

### Cocatalyst

To form an active catalytic species it is normally necessary to employ a cocatalyst as is well known in the art. Cocatalysts comprising one or more compounds of Group 13 metals, like organoaluminium or organoboron or borate compounds used to activate metallocene catalysts are suitable for use in this invention.

The catalyst systems employed in the current invention may comprise (i) a complex as defined herein; and normally (ii) an aluminium alkyl compound (or other appropriate cocatalyst), or the reaction product thereof. Thus the cocatalyst is preferably an alumoxane, like methylalumoxane (MAO).

The aluminoxane cocatalyst can be one of formula (X):

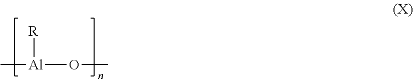

where n is usually from 6 to 20 and R has the meaning below.

Alumoxanes are formed for example by partial hydrolysis of organoaluminum compounds, for example those of the formula AlR₃ where R can be, for example, H, C1-C10 alkyl, preferably C1-C5 alkyl, or C3-10-cycloalkyl, C7-C12 -arylalkyl or alkylaryl and/or phenyl or naphthyl. The resulting oxygen-containing alumoxanes are not in general pure compounds but mixtures of oligomers of the formula (X).

The preferred alumoxane is methylalumoxane (MAO). Since the alumoxanes used according to the invention as cocatalysts are not, owing to their mode of preparation, pure compounds, the molarity of alumoxane solutions hereinafter is based on their aluminium content.

According to the present invention, also a boron containing cocatalyst can be used instead of, or in combination with, the alumoxane cocatalyst

It will be appreciated by the skilled person that where boron based cocatalysts are employed in the absence of alumoxane, it is normal to pre-alkylate the complex by reaction thereof with an aluminium alkyl compound, such as TIBA. This procedure is well known and any suitable aluminium alkyl, e.g. Al(C₁₋₆-alkyl)₃. can be used. Preferred aluminium alkyl compounds are triethylaluminium, tri-isobutylaluminium, tri-isohexylaluminium, tri-n-octylaluminium and tri-isooctylaluminium.

Alternatively, when a borate cocatalyst is used in the absence of alumoxane, the metallocene catalyst complex is in its alkylated version, that is for example a dimethyl or dibenzyl metallocene catalyst complex can be used.

Boron based cocatalysts of interest include those of formula (Z)

BY₃ (Z)

wherein Y is the same or different and is a hydrogen atom, an alkyl group of from 1 to about 20 carbon atoms, an aryl group of from 6 to about 15 carbon atoms, alkylaryl, arylalkyl, haloalkyl or haloaryl each having from 1 to 10 carbon atoms in the alkyl radical and from 6-20 carbon atoms in the aryl radical or fluorine, chlorine, bromine or iodine. Preferred examples for Y are haloaryl like p-fluorophenyl, 3,5-difluorophenyl, pentafluorophenyl, 3,4,5-trifluorophenyl and 3,5-di(trifluoromethyl)phenyl. Preferred options are trifluoroborane, tris(4-fluorophenyl)borane, tris(3,5-difluorophenyl)borane, tris(4-fluoromethylphenyl)borane, tris(2,4,6-trifluorophenyl)borane, tris(penta-fluorophenyl)borane, tris(3,5-difluorophenyl)borane and/or tris (3,4,5-trifluorophenyl)borane.

Particular preference is given to tris(pentafluorophenyl)borane.

However it is preferred that borates are used, i.e. compounds containing a borate anion and an acidic cation. Such ionic cocatalysts preferably contain a non-coordinating anion such as tetrakis(pentafluorophenyl)borate. Suitable cations are protonated amine or aniline derivatives such as methylammonium, anilinium, dimethylammonium, diethylammonium, N-methylanilinium, diphenylammonium, N,N-dimethylanilinium, trimethylammonium, triethylammonium, tri-n-butylammonium, methyldiphenylammonium, pyridinium, p-bromo-N,N-dimethylanilinium or p-nitro-N,N-dimethylanilinium.

Preferred ionic compounds which can be used according to the present invention include:
tributylammoniumtetra(pentafluorophenyl)borate,
tributylammoniumtetra(trifluoromethylphenyl)borate,
tributylammoniumtetra(4-fluorophenyl)borate,
N,N-dimethylcyclohexylammoniumtetrakis(pentafluorophenyl)borate,
N,N-dimethylbenzylammoniumtetrakis(pentafluorophenyl)borate,
N,N-dimethylaniliniumtetrakis(pentafluorophenyl)borate,
N,N-di(propyl)ammoniumtetrakis(pentafluorophenyl)borate,
di(cyclohexyl)ammoniumtetrakist(pentafluorophenyl)borate,
triphenylcarbeniumtetrakis(pentafluorophenyl)borate,
or ferroceniumtetrakis(pentafluorophenyl)borate.

Preference is given to triphenylcarbeniumtetrakis(pentafluorophenyl) borate,
N,N-dimethylaniliniumtetrakis(pentafluorophenyl)borate,
N,N-dimethylcyclohexylammoniumtetrakis(pentafluorophenyl)borate and
N,N-dimethylbenzylammoniumtetrakis(pentafluorophenyl)borate.
   In particular, triphenylcarbeniumtetrakis(pentafluorophenyl)borate and N,N-dimethylaniliniumtetrakis(pentafluorophenyl)borate are especially preferred.

Thus the use of Ph₃CB(PhF₅)₄ and analogues therefore are especially favoured.

According to the present invention, the preferred cocatalysts are alumoxanes, more preferably methylalumoxanes in combination with a borate cocatalyst such as N,N-dimethylammonium-tetrakispentafluorophenylborate and Ph₃CB(PhF₅)₄. The combination of methylalumoxane and a tritylborate is especially preferred.

Suitable amounts of cocatalyst will be well known to the skilled person. The molar ratio of feed amounts of boron to the metal ion of the metallocene may be in the range 0.1:1 to 10:1 mol/mol, preferably 0.3:1 to 7:1, especially 0.3:1 to 5:1 mol/mol.

The molar ratio of Al in the aluminoxane to the metal ion of the metallocene may be in the range 1:1 to 2000: 1 mol/mol, preferably 10:1 to 1000:1, and more preferably 50:1 to 500:1 mol/mol.

The metallocene catalyst may contain from 10 to 100 μmol of the metal ion of the metallocene per gram of silica, and 5 to 10 mmol of Al per gram of silica.

### Catalyst Manufacture

The metallocene catalysts can be used in supported or unsupported form. The particulate support material used is preferably an organic or inorganic material, such as silica, alumina or zirconia or a mixed oxide such as silica-alumina, in particular silica, alumina or silica-alumina. The use of a silica support is preferred. The skilled person is aware of the procedures required to support a metallocene catalyst.

Especially preferably the support is a porous material so that the complex may be loaded into the pores of the support, e.g. using a process analogous to those described in WO94/14856 (Mobil), WO95/12622 (Borealis) and WO2006/097497. The particle size is not critical but is preferably in the range 5 to 200 μm, more preferably 20 to 80 μm. The use of these supports is routine in the art. Especially preferred procedures for producing such supported catalysts are those described in WO 2020/239598 and WO 2020/239603.

In one particularly preferred embodiment, no external carrier is used but the catalyst is still presented in solid particulate form. Thus, no external support material, such as inert organic or inorganic carrier, for example silica as described above is employed.

In order to provide the catalyst in solid form but without using an external carrier, it is preferred if a liquid/liquid emulsion system is used. The process involves forming dispersing catalyst components (i) and (ii) in a solvent, and solidifying said dispersed droplets to form solid particles.

In particular, the method involves preparing a solution of one or more catalyst components; dispersing said solution in an solvent to form an emulsion in which said one or more catalyst components are present in the droplets of the dispersed phase; immobilising the catalyst components in the dispersed droplets, in the absence of an external particulate porous support, to form solid particles comprising the said catalyst, and optionally recovering said particles.

This process enables the manufacture of active catalyst particles with improved morphology, e.g. with a predetermined spherical shape, surface properties and particle size and without using any added external porous support material, such as an inorganic oxide, e.g. silica. By the term “preparing a solution of one or more catalyst components” is meant that the catalyst forming compounds may be combined in one solution which is dispersed to the immiscible solvent, or, alternatively, at least two separate catalyst solutions for each part of the catalyst forming compounds may be prepared, which are then dispersed successively to the solvent.

In a preferred method for forming the catalyst at least two separate solutions for each or part of said catalyst may be prepared, which are then dispersed successively to the immiscible solvent.

More preferably, a solution of the complex comprising the transition metal compound and the cocatalyst is combined with the solvent to form an emulsion wherein that inert solvent forms the continuous liquid phase and the solution comprising the catalyst components forms the dispersed phase (discontinuous phase) in the form of dispersed droplets. The droplets are then solidified to form solid catalyst particles, and the solid particles are separated from the liquid and optionally washed and/or dried. The solvent forming the continuous phase may be immiscible to the catalyst solution at least at the conditions (e.g. temperatures) used during the dispersing step.

The term “immiscible with the catalyst solution” means that the solvent (continuous phase) is fully immiscible or partly immiscible i.e. not fully miscible with the dispersed phase solution.

Preferably said solvent is inert in relation to the compounds of the catalyst system to be produced.

Full disclosure of the necessary process can be found in WO03/051934.

The inert solvent must be chemically inert at least at the conditions (e.g. temperature) used during the dispersing step. Preferably, the solvent of said continuous phase does not contain dissolved therein any significant amounts of catalyst forming compounds. Thus, the solid particles of the catalyst are formed in the droplets from the compounds which originate from the dispersed phase (i.e. are provided to the emulsion in a solution dispersed into the continuous phase).

The terms “immobilisation” and “solidification” are used herein interchangeably for the same purpose, i.e. for forming free flowing solid catalyst particles in the absence of an external porous particulate carrier, such as silica. The solidification happens thus within the droplets. Said step can be effected in various ways as disclosed in said WO03/051934. Preferably solidification is caused by an external stimulus to the emulsion system such as a temperature change to cause the solidification. Thus in said step the catalyst component (s) remain “fixed” within the formed solid particles. It is also possible that one or more of the catalyst components may take part in the solidification/immobilisation reaction.

Accordingly, solid, compositionally uniform particles having a predetermined particle size range can be obtained.

Furthermore, the particle size of the catalyst particles of the invention can be controlled by the size of the droplets in the solution, and spherical particles with a uniform particle size distribution can be obtained.

Continuous or semicontinuous processes are also possible for producing the catalyst.

### Catalyst Off-Line Prepolymerisation

The use of the heterogeneous catalysts, where no external support material is used (also called “self-supported” catalysts) might have, as a drawback, a tendency to dissolve to some extent in the polymerisation media, i.e. some active catalyst components might leach out of the catalyst particles during slurry polymerisation, whereby the original good morphology of the catalyst might be lost. These leached catalyst components are very active possibly causing problems during polymerisation. Therefore, the amount of leached components should be minimized, i.e. all catalyst components should be kept in heterogeneous form.

Furthermore, the self-supported catalysts generate, due to the high amount of catalytically active species in the catalyst system, high temperatures at the beginning of the polymerisation which may cause melting of the product material. Both effects, i.e. the partial dissolving of the catalyst system and the heat generation, might cause fouling, sheeting and deterioration of the polymer material morphology.

In order to minimise the possible problems associated with high activity or leaching, it is possible to “off line prepolymerise” the catalyst before using it in polymerisation process.

It has to be noted that off line prepolymerisation in this regard is part of the catalyst preparation process, being a step carried out after a solid catalyst is formed. The catalyst off line prepolymerisation step is not part of the actual polymerisation process configuration comprising a prepolymerisation step. After the catalyst off line prepolymerisation step, the solid catalyst can be used in polymerisation.

Catalyst “off line prepolymerisation” takes place following the solidification step of the liquid-liquid emulsion process. Pre-polymerisation may take place by known methods described in the art, such as that described in WO 2010/052263, WO 2010/052260 or WO 2010/052264. Preferable embodiments of this aspect of the invention are described herein.

As monomers in the catalyst off-line prepolymerisation step preferably alpha-olefins are used. Preferable C₂-C₁₀ olefins, such as ethylene, propylene, 1-butene, 1-pentene, 1-hexene, 4-methyl-1-pentene, 1-heptene, 1-octene, 1-nonene 1-decene, styrene and vinylcyclohexene are used. Most preferred alpha-olefins are ethylene and propylene, especially propylene.

The catalyst off-line prepolymerisation may be carried out in gas phase or in an inert diluent, typically oil or fluorinated hydrocarbon, preferably in fluorinated hydrocarbons or mixture of fluorinated hydrocarbons. Preferably perfluorinated hydrocarbons are used. The melting point of such (per)fluorinated hydrocarbons is typically in the range of 0 to 140° C., preferably 30 to 120° C., like 50 to 110° C.

Where the catalyst off line prepolymerisation is done in fluorinated hydrocarbons, the temperature for the pre-polymerisation step is below 70° C., e.g. in the range of −30 to 70° C., preferably 0 to 65° C. and more preferably in the range 20 to 55° C. Pressure within the reaction vessel is preferably higher than atmospheric pressure to minimize the eventual leaching of air and/or moisture into the catalyst vessel. Preferably the pressure is in the range of at least 1 to 15 bar, preferably 2 to 10 bar. The reaction vessel is preferably kept in an inert atmosphere, such as under nitrogen or argon or similar atmosphere.

Off line prepolymerisation is continued until the desired pre-polymerisation degree, defined as weight of polymer matrix/weight of solid catalyst before pre-polymerisation step, is reached. The degree is below 25, preferably 0.5 to 10.0, more preferably 1.0 to 8.0, most preferably 2.0 to 6.0.

Use of the off-line catalyst prepolymerisation step offers the advantage of minimising leaching of catalyst components and thus local overheating.

After off line prepolymerisation, the catalyst can be isolated and stored.

### Applications

The amorphous ethylene propylene copolymers and heterophasic polypropylene resins of the invention can be used in the manufacture of an article such as a flexible pipe/tube, profile, pad, cable insulation, sheet or film. These articles are useful in the medical and general packaging area but also for technical purposes like electrical power cables or geomembranes. Alternatively, the amorphous ethylene propylene copolymer or heterophasic polypropylene resin can be used in impact modification of a composition for injection moulding of articles, such as for technical applications in the automotive area.

For impact modification, the inventive amorphous ethylene propylene copolymer or heterophasic polypropylene resin may be blended with a further polymer. Thus, the invention also relates to polymer blends comprising the amorphous ethylene propylene copolymers or heterophasic polypropylene resins of the invention, in particular blends of either of these with other propylene polymers. The amorphous ethylene propylene copolymer of the invention may form 5 to 50 wt % of such a blend, such as 10 to 40 wt %, in particular 15 to 30 wt % of such a blend, relative to the total weight of the blend. Likewise, the heterophasic polypropylene resin of the invention may form 5 to 50 wt % of such a blend, such as 10 to 40 wt %, in particular 15 to 30 wt % of such a blend, relative to the total weight of the blend.

The amorphous ethylene propylene copolymer or heterophasic polypropylene resin might be mixed with a polypropylene having a higher MFR₂, such as at least 10 g/10 min. In particular, it can be mixed with polypropylenes used in car parts. Such polypropylenes may be homopolymers. Preferably they will not be other amorphous polymers like another EPR.

The polymers and resins of the invention are useful in the manufacture of a variety of end articles such as films (cast, blown or BOPP films), moulded articles (e.g. injection moulded, blow moulded, rotomoulded articles), extrusion coatings and so on. Preferably, articles comprising the films of the invention are used in packaging. Packaging of interest include heavy duty sacks, hygiene films, lamination films, and soft packaging films.

The invention will now be illustrated by reference to the following non-limiting examples.

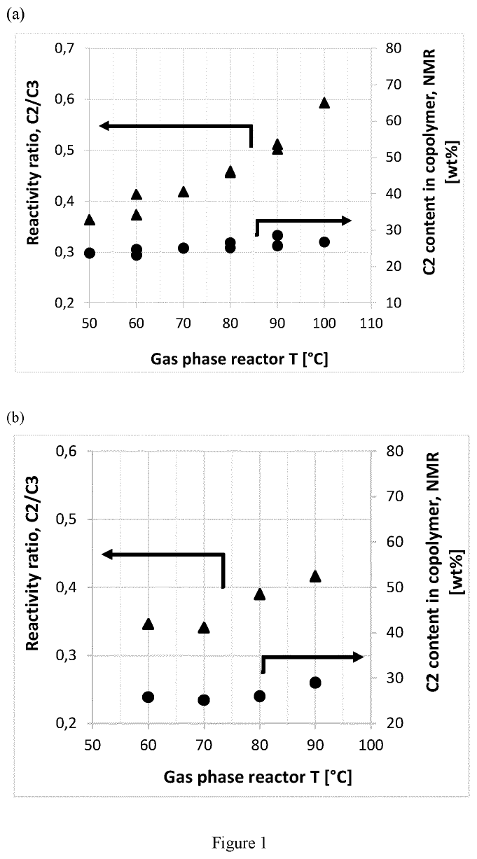

FIG. 1: Variation of R with temperature. (a) Cat1 (b) Cat3

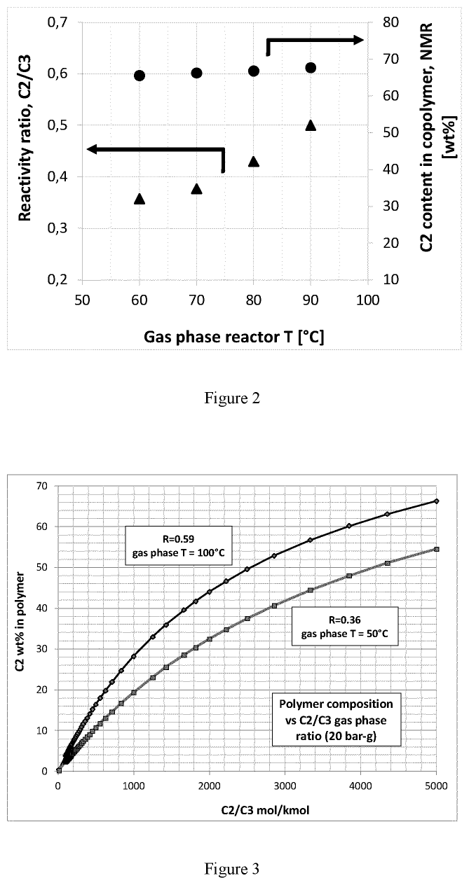

FIG. 2. Variation of R with temperature for copolymers with C2˜67 wt % with Cat2.

FIG. 3. Correlation between gas phase comonomer feed ratio and copolymer composition at the two reactivity ratios obtained at 20 bar-g at 50 (R=0.36) and 100° C. (R=0.59).

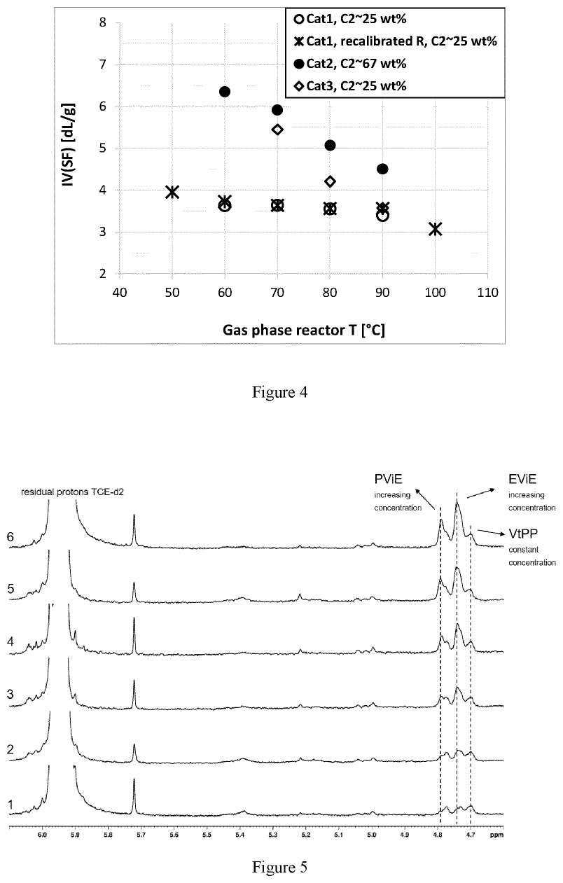

FIG. 4. Decrease of molecular weight with temperature for Cat1, Cat 2 and Cat3

FIG. 5: Expanded ¹H NMR spectra between 6.1 and 4.6 ppm of six soluble fractions of HECOS with similar C2 contents polymerised at different temperatures with Cat1. (1) CE5, Tp=50° C. (2) CE1, Tp=60° C. (3) CE2, Tp=70° C. (4) IE1, Tp=80° C. (5) IE6, Tp=90° C. and (6) IE7, Tp=100° C.

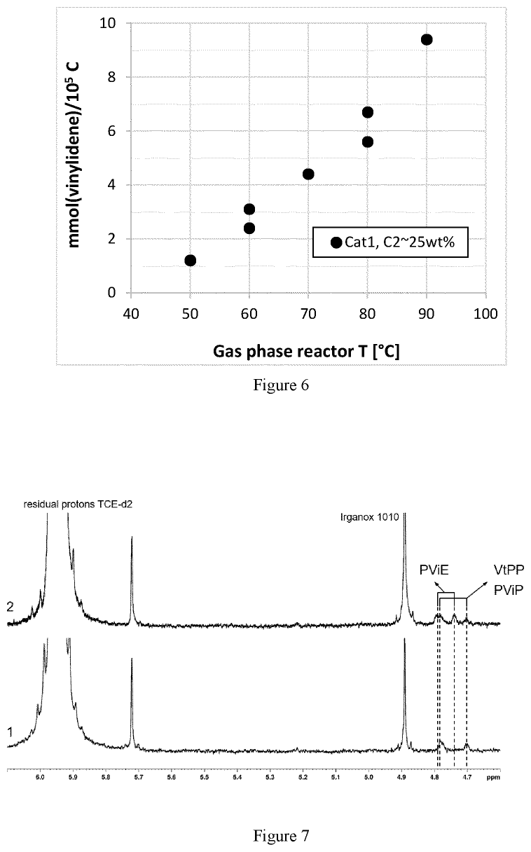

FIG. 6. Dependence of the amount of internal unsaturations of the xylene soluble fractions of hecos, produced with Cat1, on gas phase reactor temperature.

FIG. 7. Expanded ¹H NMR spectra between 6.1 and 4.6 ppm of (1) CE9 and (2) CE10 with results of vinylidene being reported in Table 7.

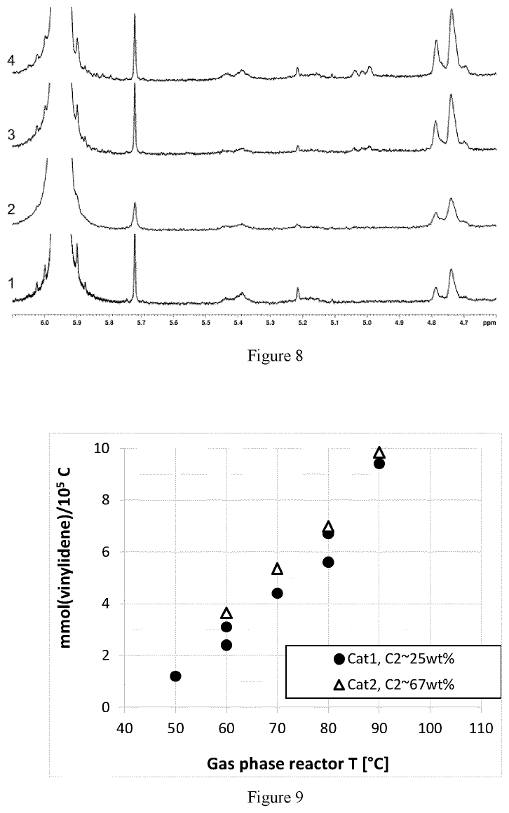

FIG. 8. Expanded ¹H NMR spectra between 6.1 and 4.6 ppm of four soluble fractions of HECOS of similar C2 content polymerised at different temperatures with Cat3. (1) CE4, Tp=60° C. (2) CE5, Tp=70° C. (3) IE3, Tp=80° C., (4) IE4, Tp=90° C.

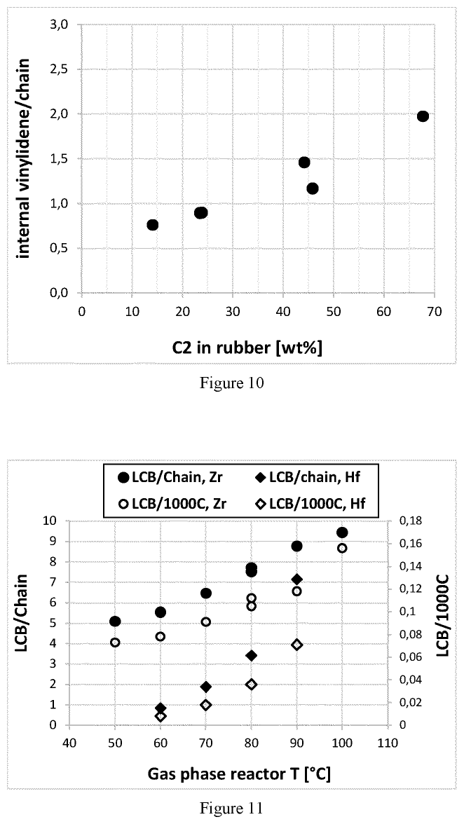

FIG. 9. Dependence of the amount of internal unsaturations of the xylene soluble fractions of hecos, produced with Cat2, on gas phase reactor temperature (♦). The data from Cat1 of FIG. 6 (●) are also included for comparison.

FIG. 10. Internal vinylidenes per chain (as measured by ¹H NMR) as a function of C2 content in the rubber, in gas phase C2/C3 copolymerisations at 70° C., 20 bar-g with Cat2.

FIG. 11. Dependence on gas phase reactor temperature of the amount of LCB of the soluble fractions of hecos, produced with Cat3(♦), and with Cat1 (●)

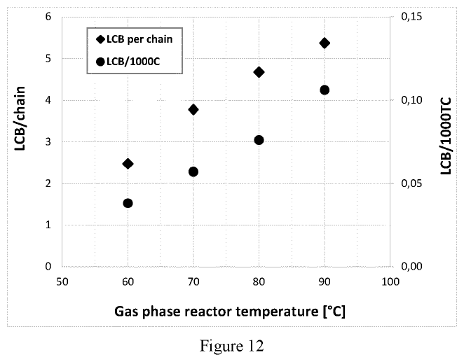

FIG. 12. Dependence on gas phase reactor temperature of the amount of LCB of the soluble fractions of hecos, produced with Cat2 at ˜70 wt % C2

### EXAMPLES

### Measurement Methods

### Al, B and Zr Determination (ICP-Method)

In a glovebox, an aliquot of the catalyst (ca. 40 mg) was weighed into glass weighting boat using analytical balance. The sample was then allowed to be exposed to air overnight while being placed in a steel secondary container equipped with an air intake. Then 5 mL of concentrated (65%) nitric acid was used to rinse the content of the boat into the Xpress microwave oven vessel (20 mL). A sample was then subjected to a microwave-assisted digestion using MARS 6 laboratory microwave unit over 35 minutes at 150° C. The digested sample was allowed to cool down for at least 4 h and then was transferred into a glass volumetric glass flask of 100 mL volume. Standard solutions containing 1000 mg/L Y and Rh (0.4 mL) were added. The flask was then filled up with distilled water and shaken well. The solution was filtered through 0.45 um Nylon syringe filters and then subjected to analysis using Thermo iCAP 6300 ICP-OES and iTEVA software.

The instrument was calibrated for Al, B, Hf, Mg, Ti and Zr using a blank (a solution of 5% HNO₃) and six standards of 0.005 mg/L, 0.01 mg/L, 0.1 mg/L, 1 mg/L, 10 mg/L and 100 mg/L of Al, B, Hf, Mg, Ti and Zr in solutions of 5% HNO₃ distilled water. However, not every calibration point was used for each wavelength. Each calibration solution contained 4 mg/L of Y and Rh standards. Al 394.401 nm was calibrated using the following calibration points: blank, 0.1 mg/L, 1 mg/L, 10 mg/L and 100 mg/L. Al 167.079 nm was calibrated as Al 394.401 nm excluding 100 mg/L and Zr 339.198 nm using the standards of blank, 0.01 mg/L, 0.1 mg/L, 1 mg/L, 10 mg/L and 100 mg/L. Curvilinear fitting and 1/concentration weighting was used for the calibration curves.

Immediately before analysis the calibration was verified and adjusted (instrument reslope function) using the blank and a 10 mg/L Al, B, Hf, Mg, Ti and Zr standard which had 4 mg/L Y and Rh. A quality control sample (QC: 1 mg/L Al, Au, Be, Hg & Se; 2 mg/L Hf & Zr, 2.5 mg/L As, B, Cd, Co, Cr, Mo, Ni, P, Sb, Sn & V; 4 mg/L Rh & Y; 5 mg/L Ca, K, Mg, Mn, Na & Ti; 10 mg/L Cu, Pb and Zn; 25 mg/L Fe and 37.5 mg/L Ca in a solution of 5% HNO3 in distilled water) was run to confirm the reslope for Al, B, Hf, Mg, Ti and Zr. The QC sample was also run at the end of a scheduled analysis set.

The content for Zr was monitored using Zr 339.198 nm {99} line. The content of aluminium was monitored via the 167.079 nm {502} line, when Al concentration in test portion was under 2 wt % and via the 394.401 nm {85} line for Al concentrations above 2 wt %. Y 371.030 nm {91} was used as internal standard for Zr 339.198 nm and Al 394.401 nm and Y 224.306 nm {450} for Al 167.079 nm. The content for B was monitored using B 249 nm line.

The reported values were back calculated to the original catalyst sample using the original mass of the catalyst aliquot and the dilution volume

### DSC Analysis

The melting point (Tₘ) and crystallization temperature (T_{c}) were determined on a DSC200 TA instrument, by placing a 5-7 mg polymer sample, into a closed DSC aluminium pan, heating the sample from −10° C. to 210° C. at 10° C./min, holding for 5 min at 210° C., cooling from 210° C. to −10° C., holding for 5 min at −10° C., heating from −10° C. to 210° C. at 10° C./min. The reported Tₘ is the maximum of the curve from the second heating scan and T_{c} is the maximum of the curve of the cooling scan.

### Melt Flow Rate

The melt flow rate (MFR) is determined according to ISO 1133 and is indicated in g/10 min. The MFR is an indication of the flowability, and hence the processability, of the polymer. The higher the melt flow rate, the lower the viscosity of the polymer. The MFR is determined at 230° C. at the loading of 2.16 kg (MFR²).

### Quantification of Microstructure by NMR Spectroscopy

Quantitative nuclear-magnetic resonance (NMR) spectroscopy was used to quantify the ethylene content and the isotacticity of the copolymers.

Quantitative ¹³C {¹H} NMR spectra were recorded in the solution-state using a Bruker Avance III 400 NMR spectrometer operating at 400.15 and 100.62 MHz for ¹H and ¹³C respectively. All spectra were recorded using a ¹³C optimised 10 mm extended temperature probehead at 125° C. using nitrogen gas for all pneumatics. Approximately 200 mg of material was dissolved in 3 ml of 1.2-tetrachloroethane-d₂ (TCE-d₂) along with chromium-(III)-acetylacetonate (Cr(acac)₃) resulting in a 65 mM solution of relaxation agent in solvent as described in G. Singh, A. Kothari, V. Gupta, Polymer Testing 2009, 28 (5), 475.

To ensure a homogenous solution, after initial sample preparation in a heat block, the NMR tube was further heated in a rotatory oven for at least 1 hour. Upon insertion into the magnet the tube was spun at 10 Hz. This setup was chosen primarily for the high resolution and quantitatively needed for accurate ethylene content quantification. Standard single-pulse excitation was employed without NOE, using an optimised tip angle, 1 s recycle delay and a bi-level WALTZ16 decoupling scheme as described in Z. Zhou, R. Kuemmerle, X. Qiu, D. Redwine, R. Cong, A. Taha, D. Baugh, B. Winniford, J. Mag. Reson. 187 (2007) 225 and V. Busico, P. Carbonniere, R. Cipullo, C. Pellecchia, J. Severn, G. Talarico, Macromol. Rapid Commun. 2007, 28, 1128. A total of 6144 (6 k) transients were acquired per spectra.

Quantitative ¹³C{¹H} NMR spectra were processed, integrated and relevant quantitative properties determined from the integrals. All chemical shifts were indirectly referenced to the central methylene group of the ethylene block (EEE) at 30.00 ppm using the chemical shift of the solvent. This approach allowed comparable referencing even when this structural unit was not present.

With characteristic signals corresponding to 2, 1 erythro regiodefects observed (as described in L. Resconi, L. Cavallo, A. Fait, F. Piemontesi, Chem. Rev. 2000, 100 (4), 1253, in Cheng, H. N., Macromolecules 1984, 17, 1950, and in W-J. Wang and S. Zhu, Macromolecules 2000, 33, 1157) the correction for the influence of the regiodefects on determined properties was required. Characteristic signals corresponding to other types of regiodefects were not observed.

Characteristic signals corresponding to the incorporation of ethylene were observed (as described in Cheng, H. N., Macromolecules 1984, 17, 1950) and the comonomer fraction calculated as the fraction of ethylene in the polymer with respect to all monomer in the polymer:

fE=(E/(P+E)

The comonomer fraction was quantified using the method of W-J. Wang and S. Zhu, Macromolecules 2000, 33, 1157, through integration of multiple signals across the whole spectral region in the ¹³C {¹H} spectra. This method was chosen for its robust nature and ability to account for the presence of regio-defects when needed. Integral regions were slightly adjusted to increase applicability across the whole range of encountered comonomer contents.

The mole percent comonomer incorporation was calculated from the mole fraction:

E [mol %]=100*fE

The weight percent comonomer incorporation was calculated from the mole fraction:

E [wt %]=100*(fE*28.06)/((fE*28.06)+((1−fE)*42.08))

The isotacticity of the copolymer was determined according to known methods, for example as described in Macromolecules 2005, vol. 38, pp. 3054-3059.

The isotacticity of the homopolymeric matrix was determined according to the following method:

Quantitative ¹³C{¹H} NMR spectra recorded in the solution-state using a Bruker Avance III 400 NMR spectrometer operating at 400.15 and 100.62 MHz for ¹H and ¹³C respectively. All spectra were recorded using a ¹³C optimised 10 mm selective excitation probehead at 125° C. using nitrogen gas for all pneumatics. Approximately 200 mg of material was dissolved in 1,2-tetrachloroethane-d₂ (TCE-d₂). This setup was chosen primarily for the high resolution needed for tacticity distribution quantification (Busico, V., Cipullo, R., Prog. Polym. Sci. 26 (2001) 443; Busico, V.; Cipullo, R., Monaco, G., Vacatello, M., Segre, A. L., Macromolecules 30 (1997) 6251). Standard single-pulse excitation was employed utilising the NOE and bi-level WALTZ16 decoupling scheme (Zhou, Z., Kuemmerle, R., Qiu, X., Redwine, D., Cong, R., Taha, A., Baugh, D. Winniford, B., J. Mag. Reson. 187 (2007) 225; Busico, V., Carbonniere, P., Cipullo, R., Pellecchia, R., Severn, J., Talarico, G., Macromol. Rapid Commun. 2007, 28, 11289). A total of 8192 (8 k) transients were acquired per spectra. Quantitative ¹³C{¹H} NMR spectra were processed, integrated and relevant quantitative properties determined from the integrals using proprietary computer programs. All chemical shifts are internally referenced to the methyl signal of the isotactic pentad mmmm at 21.85 ppm.

The tacticity distribution was quantified through integration of the methyl region between 23.6 and 19.7 ppm correcting for any sites not related to the stereo sequences of interest (Busico, V., Cipullo, R., Prog. Polym. Sci. 26 (2001) 443; Busico, V., Cipullo, R., Monaco, G., Vacatello, M., Segre, A. L., Macromolecules 30 (1997) 6251). The pentad isotacticity was determined through direct integration of the methyl region and reported as either the mole fraction or percentage of isotactic pentad mmmm with respect to all steric pentads i.e. [mmmm] =mmmm/sum of all steric pentads. When appropriate integrals were corrected for the presence of sites not directly associated with steric pentads.

Characteristic signals corresponding to regio irregular propene insertion were observed (Resconi, L., Cavallo, L., Fait, A., Piemontesi, F., Chem. Rev. 2000, 100, 1253). The presence of secondary inserted propene in the form of 2,1 erythro regio defects was indicated by the presence of the two methyl signals at 17.7 and 17.2 ppm and confirmed by the presence of other characteristic signals. The amount of 2,1 erythro regio defects was quantified using the average integral (e) of the e6 and e8 sites observed at 17.7 and 17.2 ppm respectively, i.e. e=0.5*(e6+e8). Characteristic signals corresponding to other types of regio irregularity were not observed. The amount of primary inserted propene (p) was quantified based on the integral of all signals in the methyl region (CH3) from 23.6 to 19.7 ppm paying attention to correct for other species included in the integral not related to primary insertion and for primary insertion signals excluded from this region such that p=CH3+2*e. The relative content of a specific type of regio defect was reported as the mole fraction or percentage of said regio defect with respect all observed forms of propene insertion i.e. sum of all primary (1,2), secondary (2,1) and tertiary (3,1) inserted propene units, e.g. [21e]=e/(p+e+t+i). The total amount of secondary inserted propene in the form of 2,1-erythro or 2,1-threo regio defects was quantified as sum of all said regio irregular units, i.e. [21]=[21e]+[21t].

### Determination of Xylene Soluble Fraction (XS)

The xylene soluble fraction (XS) as defined and described in the present invention is determined in line with ISO 16152 as follows: 2.5±0.1 g of the polymer were dissolved in 250 ml o-xylene under reflux conditions and continuous stirring, under nitrogen atmosphere. After 30 minutes, the solution was allowed to cool, first for 15 minutes at ambient temperature and then maintained for 30 minutes under controlled conditions at 25±0.5° C. The solution was filtered through filter paper. For determination of the xylene soluble content, an aliquot (100 ml) of the filtrate was taken. This aliquot was evaporated in nitrogen flow and the residue dried under vacuum at 100° C. until constant weight is reached.

The xylene soluble fraction (weight percent) can then be determined as follows:

XS %=(100×ml×v0)/(m0×1l),

wherein m0 designates the initial polymer amount (grams), ml defines the weight of residue (grams), v0 defines the initial volume (millilitre) and v1 defines the volume of the analysed sample (millilitre).

To obtain the amorphous copolymer fraction for further characterisation with GPC and NMR, the remaining xylene soluble filtrate was precipitated with acetone. The precipitated polymer was filtered and dried in the vacuum oven at 100° C. to constant weight.

### Intrinsic Viscosity

Intrinsic viscosity (iV) is measured according to DIN ISO 1628/1 (2009) and /3 (2010) (in Decalin at 135° C.) The intrinsic viscosity (iV) value increases with the molecular weight of a polymer.

### Crystex Method

The crystalline (CF) and soluble fractions (SF) of the heterophasic propylene resins as well as the comonomer content and intrinsic viscosities of the respective fractions were analyzed by the Crystex method,. The crystalline and amorphous fractions are separated through temperature cycles of dissolution at 160° C., crystallization at 40° C. and re-dissolution in 1,2,4-trichlorobenzene (1,2,4-TCB) at 160° C. Quantification of SF and CF and determination of ethylene content (C2) are achieved by means of an infrared detector (IR4) and an online 2-capillary viscometer is used for determination of the intrinsic viscosity (iV).

IR4 detector is multiple wavelength detector detecting IR absorbance at two different bands (CH3 and CH2) for the determination of the concentration determination and the Ethylene content in Ethylene-Propylene copolymers. IR4 detector is calibrated with series of EP copolymers with known Ethylene content in the range of 2 wt.-% to 69 wt.-% (determined by 13C-NMR).

Amount of Soluble fraction (SF) and Crystalline Fraction (CF) are correlated through the XS calibration to the “Xylene Soluble” (XS) quantity and respectively Xylene Insoluble (XI) fractions, determined according to standard gravimetric method as per ISO16152 (2005). XS calibration is achieved by testing various EP copolymers with XS content in the range 2-31 wt %.

Intrinsic viscosity (iV) of the parent EP copolymer and its soluble and crystalline fractions are determined with a use of an online 2-capillary viscometer and are correlated to corresponding iV determined in decalin according to ISO 1628-3 (2010).

Calibration is achieved with several commercial EP PP copolymers with iV=2-4 dL/g.

A sample of the PP composition to be analyzed is weighed out in concentrations of 10 mg/ml to 20 mg/ml. After automated filling of the vial with 1,2,4-TCB containing 250 mg/l 2,6-tert-butyl-4-methylphenol (BHT) as antioxidant, the sample is dissolved at 160° C. until complete dissolution is achieved, usually for 60 min, with constant stirring of 800 rpm.

A defined volume of the sample solution is injected into the column filled with inert support where the crystallization of the sample and separation of the soluble fraction from the crystalline part is taking place. This process is repeated two times. During the first injection the whole sample is measured at high temperature, determining the iV[dl/g] and the C2[wt %] of the PP composition. During the second injection the soluble fraction (at low temperature) and the crystalline fraction (at high temperature) with the crystallization cycle are determined (Wt % SF, Wt % C2, iV).

### Quantification of Internal Vinylidene Unsaturations

### ¹H NMR Measurement Conditions

Quantitative ¹H NMR spectra recorded in the solution-state using a Bruker Avance III 400 NMR spectrometer operating at 400.15 MHz. All spectra were recorded using a ¹³C optimised 10 mm selective excitation probehead at 125° C. using nitrogen gas for all pneumatics. Approximately 250 mg of material was dissolved in 1,2-tetrachloroethane-d₂ (TCE-d₂) using approximately 3 mg of Hostanox 03 (CAS 32509-66-3) as stabiliser. Standard single-pulse excitation was employed utilising a 30 degree pulse, a relaxation delay of 5 s and 10 Hz sample rotation. A total of 512 transients were acquired per spectra using 4 dummy scans. This setup was chosen primarily for the high resolution needed for unsaturation quantification and stability of the vinylidene groups. Quantitative ¹H spectra were processed, integrated and relevant quantitative properties determined from the integrals. All chemical shifts were indirectly referenced to TMS at 0.00 ppm using the signal resulting from the residual protonated solvent at 5.95 ppm.

Quantification of total and internal vinylidene Characteristic signals corresponding to the presence of different vinylidene groups were quantified using the integral between 4.86 ppm and 4.65 ppm (I_{vinylidene}). As all vinylidene beeing represented by two protons (═CH2) per structure we can count for the total number of reporting sites per functional group:

N_{vinylidene}=I_{vinylidene}/2

The Hostanox 03 stabiliser was quantified using the integral of multiplet from the aromatic protons (I_{Hostanox}) at 6.92, 6.91, 6.69 and at 6.89 ppm and accounting for the number of reporting sites per molecule:

H=I_{Hostanox}/4

As is typical for unsaturation quantification in polyolefins the amount of unsaturation was determined with respect to total carbon atoms, even though quantified by ¹H NMR spectroscopy. This allows direct comparison to other microstructure quantities derived directly from ¹³C NMR spectroscopy.

The total amount of carbon atoms was calculated from integral of the bulk aliphatic signal between 2.60 and −1.00 (I_{bulk}) ppm with compensation for included methyl signals of the stabiliser as well as excluded unsaturated derived sites:

NCₜₒₜₐₗ=((I_{bulk}−42*H)/2)+2*N_{vinylidene}

The content of all vinylidene groups (U_{vinylidene}) was calculated as the number of unsaturated groups in the polymer per hundred thousand total carbons (100 kCHn):

U_{vinylidene}=100000*N_{vinylidene}/NCₜₒₜₐₗ

Only the internal vinylidenes are relevant for H2 evolution. In order to quantify the internal vinylidenes we need to subtract the terminal vinylidenes from the total vinylidene signal.

It is possible to split the vinylidene region into three sections A, B and C reflecting different protons and allow the quantification of only the internal vinylidenes Uint_{vinylidene} per hundred thousand total carbons (100 kCHn):

| | ¹H δ range | |
|---|---|---|
| section | [ppm] | reflected protons |
| A | 4.650-4.716 | 1 proton from VₜPP, 1 proton from VₜEE |
| B | 4.716-4.760 | 2 protons from EVᵢE, one proton from PVᵢE |
| | | and VₜEE |
| C | 4.760-4.850 | 1 proton from PVᵢE, one proton from VₜPP |

Nint_{vinylidene}=(I_{vinylidene}−(2*IA))/2

Uint_{vinylidene}=100000*Nint_{vinylidene}/NCₜₒₜₐₗ

The number of internal unsaturations per chain is obtained from the ratio between internal and terminal unsaturations (in the assumption that there is one and only one terminal unsaturation per chain):

Number of internal unsaturations (vinylidenes)=I_{vinylidene,internal}/(I_{vinylidene,total}−I_{vinylidene,terminal})

The mol of H2 produced per kg of copolymer produced equals the mol(internal vinylidenes)/kg(copolymer) and is calculated from the following equation:

Mol(H2)/kg(copolymer)=mol(internal vinylidene)/kg(copolymer)=Uint_{vinylidene}/1400

### Quantification of the Relative Amounts of Vinylidenes

essential relations and equations for the identified sections:

VtP=VtP₁+VtP₂ VtP₁=VtP₂

PViE=PViE₁+PViE₂ PViE₁=PViE₂

VtE=VtE₁+VtE₂ VtE₁=VtE₂

A=VtP₁+VtE₁

B=EViE+VtE₂+PViE₁

C=VtP₂+PViE₂

Splitting the integral of section C resulting in VtP₂ and PViE₂ and by use of the essential relations it is possible to collaps equation and obtain results for all vinylidene species:

VtE₁=A−VtP₁(VtP₁=VtP₂)→VtE₁=A−VtP₂

EViE=B−VtE₂−PViE₁(PViE₁=PViE₂, VtE₁=VtE₂)→EViE=B−VtE₁−PViE₂

relative amounts of vinylidenes in [%]:

VtP [%]=100*VtP/VtP+VtE+EViE+PViE

VtE [%]=100*VtE/VtP+VtE+EViE+PViE

EViE [%]=100*EViE/VtP+VtE+EViE+PViE

PViE [%]=100*PViE/VtP+VtE+EViE+PViE

absolute amounts in vinylidene/100000 C:

VtP=U_{vinylidene}*VtP[%]/b 100

VtE=U_{vinylidene}*VtE[%]/100

EViE=U_{vinylidene}*EViE[%]/100

PViE=U_{vinylidene}*PViE[%]/100

### Quantification of Average Carbons Per Chain, Average Mw and Degree of Polymerisation DP

Assuming that every chain has 2 endgroups it is possible to quantify the average amount of total carbons per chain:

average totalC/chain=2*100000/(VtP+VtE)

The average Mw [g/mol] of the polymer can be quantified by multiplying the average totalC/chain by 14:

Mw_{Polymer}=average totalC/chain*14

The average molecular mass of the combined monomer (Mw_{combmonomer} [g/mol]) quantified by the mol fractions of both mol % C2 and mol % C3 is needed for the quantification of the degree of polymerisation DP:

Mw_{combmonomer}=(mol % C2/100*28)+((100−mol % C2)/100*42)

DP=Mw_{Polymer}/Mw_{combmonomer}

### GPC Analysis

A high temperature GPC equipped with a suitable concentration detector (like IR5 or IR⁴ from PolymerChar (Valencia, Spain), an online four capillary bridge viscometer (PL-BV 400-HT), and a dual light scattering detector (PL-LS 15/90 light scattering detector) with a 15° and 90° angle was used. 3× Olexis and 1× Olexis Guard columns from Agilent as stationary phase and 1,2,4-trichlorobenzene (TCB, stabilized with 250 mg/L 2,6-Di tert butyl-4-methyl-phenol) as mobile phase at 160° C. and at a constant flow rate of 1 mL/min was applied. 200 μL of sample solution were injected per analysis. All samples were prepared by dissolving 8.0-10.0 mg of polymer in 10 mL (at 160° C.) of stabilized TCB (same as mobile phase) for 2.5 hours at 160° C. under continuous gentle shaking. The injected concentration of the polymer solution at 160° C.). (C_{160° C.}) was determined in the following way.

$${c}_{160 ° C} = \frac{{w}_{25}}{{V}_{25}} * 0 , 8772$$

With: w₂₅ (polymer weight) and V₂₅ (Volume of TCB at 25° C.).
GPC conventional: Molecular weight averages, molecular weight distribution, and polydispersity index (Mₙ, M_{w}, M_{w}/Mₙ)

### GPC

For GPC conventional (GPC_{conv}) the column set was calibrated using universal calibration (according to ISO 16014-2:2019) with 19 narrow MWD polystyrene (PS) standards in the range of 0.5 kg/mol to 11 500 kg/mol. The PS standards were dissolved at 160° C. for 15 min or alternatively at room temperatures at a concentration of 0.2 mg/ml for molecular weight higher and equal 899 kg/mol and at a concentration of 1 mg/ml for molecular weight below 899 kg/mol. The conversion of the polystyrene peak molecular weight to polyethylene molecular weights is accomplished by using the Mark Houwink equation and the following Mark Houwink constants:

K_{PS}=19×10⁻⁵ ml/g, α_{PS}=0.655

K_{PP}=39×10⁻⁵ ml/g, α_{PE}=0.725

K_{PE}=19×10⁻⁵ ml/g, α_{PE}=0.725

A third order polynomial fit was used to fit the calibration data.

All samples were prepared in the concentration range of 0.5-1 mg/ml and dissolved at 160° C. for 3 hours under continuous gentle shaking Molecular weight averages (Mz, Mw and Mn), Molecular weight distribution (MWD) and its broadness, described by polydispersity index, PD=Mw/Mn (wherein Mn is the number average molecular weight and Mw is the weight average molecular weight) were determined using the following formulas:

$${M}_{n} = \frac{{\sum }_{i = 1}^{N} {A}_{i}}{\sum ( {A}_{i} / {M}_{i} )} \qquad ( 1 )$$

$${M}_{w} = \frac{{\sum }_{i = 1}^{N} ( {A}_{i} {xM}_{i} )}{\sum {A}_{i}} \qquad ( 2 )$$

$${M}_{z} = \frac{{\sum }_{i = 1}^{N} ( {A}_{i} {xM}_{i}^{2} )}{\sum ( {A}_{i} / {M}_{i} )} \qquad ( 3 )$$

$${M}_{v} = {( \frac{{\sum }_{i = 1}^{N} ( {A}_{i} {xM}_{i}^{α + 1} )}{\sum {A}_{i}} )}^{\frac{1}{α}} \qquad ( 4 )$$

For the molecular weight averages Mz, Mw and Mn the polyolefin molecular weight (MW) was determined by GPC_{conv}, where Mz(LS), Mw(LS) and Mn(LS) stands that this molecular weight averages were obtained by GPC_{LS}.

### GPC-VISC-LS Processing

For the GPC light scattering approach (GPC_{LS}), the inter detector delay volumes were determined with a narrow PS standard (MWD=1.01) with a molar mass of 130000 g/mol. The corresponding detector constants for the light scattering detector and the online viscometer were determined with the broad standard NIST1475A (Mw=52000 g/mol and iV=1.01 dl/g). The corresponding used dn/dc for the used PE standard in TCB was 0.094 cm³/g. The calculation was performed using the Cirrus Multi-Offline SEC-Software, Version 3.2 (Agilent).

The molar mass at each elution slice was calculated by using the 15° light scattering angle. Data collection, data processing and calculation were performed using the Cirrus Multi SEC-Software Version 3.2. As dn/dc used for the determination of molecular weight a value of 0.094 was used.

The molecular weight at each slice is calculated in the manner as it is described by C. Jackson and H. G. Barth at low angle. To correlate the elution volume to the molecular weight for calculating MWD and the corresponded molecular weight averages a linear fit was applied using the molecular weight data at each slice and the corresponded retention volume.

Molecular weight averages (Mz(LS), Mw(LS) and Mn(LS)), Molecular weight distribution (MWD) and its broadness, described by polydispersity, PD(LS)=Mw(LS)/Mn(LS) (wherein Mn(LS) is the number average molecular weight and Mw(LS) is the weight average molecular weight obtained from GPC-LS) were calculated by Gel Permeation Chromatography (GPC) using the following formulas:

$${M}_{n} ( LS ) = \frac{{\sum }_{i = 1}^{N} {A}_{i}}{\sum ( {A}_{i} / {M}_{i ( LS )} )} \qquad ( 1 )$$

$${M}_{w} ( LS ) = \frac{{\sum }_{i = 1}^{N} ( {A}_{i} {xM}_{i ( LS )} )}{\sum {A}_{i}} \qquad ( 2 )$$

$${M}_{z} ( LS ) = \frac{{\sum }_{i = 1}^{N} ( {A}_{i} {xM}_{i ( LS )}^{2} )}{\sum ( {A}_{i} / {M}_{i} ( LS ) )} \qquad ( 3 )$$

For a constant elution volume interval ΔVᵢ, where Aᵢ and M_{i(LS)} are the chromatographic peak slice area and polyolefin molecular weight (MW) determined by GPC-LS.

Branching Calculation g′(85-100% Cum)

The relative amount of branching is determined using the g′-index of the branched polymer sample. The long chain branching (LCB) index is defined as g′=[η]_{br}/[η]ₗᵢₙ. It is well known that if the g′ value increases the branching content decreases. [η] is the intrinsic viscosity (iV) at 160° C. in TCB of the polymer sample at a certain molecular weight and is measured by an online viscometer and a concentration detector, where [η]ₗᵢₙ is the intrinsic viscosity (iV) of the linear polymer having the same chemical composition. The intrinsic viscosities were measured as described in the handbook of the Cirrus Multi-Offline SEC-Software Version 3.2, with use of the Solomon-Gatesman equation. The [η]ₗᵢₙ at a certain molecular weight was obtained using the equation 1 with the corresponding Mark Houwink constant:

[η]lin=K_{EPC}*M^{α} (equation 1)

The constants K and α are specific for a polymer-solvent system and M is the molecular weight obtained from LS analysis.

To account for the amount of propylene in the EP Copolymer the [K]_{EPC} needs to be modified in the following way:

K_{EPC}=(1⅓*mol.-%*(propylene))^{1+α}*K_{PE} (equation 2)

Where K_{PE}=0.00039 and α=0.725 and the propylene content is determined by ¹³C-NMR.

[η]ₗᵢₙ is the intrinsic viscosity (iV) of a linear sample and [η]_{br} the viscosity of a branched sample of the same molecular weight and chemical composition. By dividing the intrinsic viscosity of a branched sample [η]_{br} with the intrinsic viscosity (iV) of a linear polymer [η]ₗᵢₙ at the same molecular weight, the viscosity branching factor g′ can be calculated.

In this case the g′₍₈₅₋₁₀₀₎ is calculated by adding the product of g′_{M}*a_{M} in the range where the cumulative fraction is 85-100% and dividing it through the corresponded signal area of the concentration signal, aᵢ.

$${g}_{( 85 - 100 )}^{′} = \frac{{\sum }_{85}^{100} {a}_{i} * \frac{{[ η ]}_{br , i}}{{[ η ]}_{lin , i}}}{{\sum }_{85}^{100} {a}_{i}} = \frac{{\sum }_{85}^{100} {a}_{i} * {g}_{i}^{′}}{{\sum }_{85}^{100} {a}_{i}}$$

The calculation of the linear reference line as well as the calculation of the g′₍₈₅₋₁₀₀₎ is illustrated:

The number of LCB/1000TC of the high molecular weight fraction (85-100 wt % of cumulative weight fraction) is calculated using the formula 1000*M₀*B/M_{z}*N_{c}, where B is the number of LCB per chain, M₀ is the molecular weight of the repeating unit, i.e. the propylene group, —CH₂—CH(CH₃)— (42), for PP, M_{z} is the z-average molecular weight and N_{c} is the number of C-Atoms in the monomer repeating unit (3 for polypropylene). The reported LCB/1000TC and the LCB per chain values in this application always stands for number of LCB/1000TC or LCB per chain of the high molecular weight fraction (85-100 wt % of cumulative weight fraction).

B is calculated using the Zimm-Stockmayer approach according to the following equation:

$$g = \frac{6}{B} \{ \frac{1}{2} {( \frac{2 + B}{B} )}^{1 / 2} ln [ \frac{{( 2 + B )}^{1 / 2} + {( B )}^{1 / 2}}{{( 2 + B )}^{1 / 2} - {( B )}^{1 / 2}} ] - 1 \}$$

where LCB is assumed to be tri-functional (or Y-shaped) and polydispersed and g is the branching index, defined as g=Rg(br)/Rg(lin), where Rg is the radius of gyration (Y. Yu, E. Schwerdtfeger, M. McDaniel, Polymer Chemistry, 2012, 50, 1166-1179).

The branching index g can be obtained from the viscosity branching index g′ using the following correlation:

g=g′^{ϵ}

Where in this case ϵ=1.33

### Catalyst

### Synthesis

The ligands and metallocenes required to form the catalysts of the invention can be synthesised by any process and the skilled organic chemist would be able to devise various synthetic protocols for the manufacture of the necessary ligand materials. WO2007/116034 discloses the necessary chemistry. Synthetic protocols can also generally be found in WO2002/02576, WO2011/135004, WO2012/084961, WO2012/001052, WO2011/076780, WO2015/158790, WO 2018/122134 and WO 2019/179959, wherein the protocol in WO 2019/179959 is most relevant for the present invention.

Anti-dimethylsilanediyl[2-methyl-4,8-bis(3,5-dimethylphenyl)-1,5,6,7-tetrahydro-s-indacen-1-yl][2-methyl-4-(3,5-dimethylphenyl)-5-methoxy-6-tert-butylinden-1-yl] Hafnium Dichloride

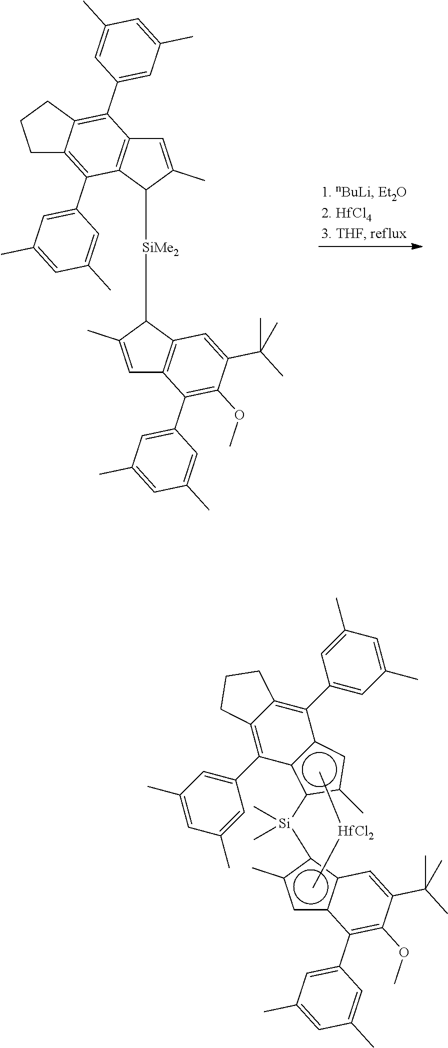

^{η}BuLi in hexanes (2.43 M, 32.2 ml, 78.25 mmol) was added in one portion to a yellowish solution of [2-methyl-4,8-bis(3,5-dimethylphenyl)-1,5,6,7-tetrahydro-s-indacen-1-yl][2-methyl-4-(3,5-dimethylphenyl)-5-methoxy-6-tert-butyl-1H-inden-1-yl]dimethylsilane (29.5 g, 39.07 mmol, 95% purity, prepared as describe above) in 250 ml of ether cooled to −50° C. This mixture was stirred for 5.5 h at room temperature, then the resulting dark red solution was cooled to −50° C., and HfCl₄ (12.52 g, 39.09 mmol) was added. The reaction mixture was stirred for 24 h at room temperature to give red solution containing LiCl precipitate. This mixture was evaporated to dryness, 150 ml of THF was added to the residue, and the resulting mixture was heated for 24 h at 65° C. The so obtained mixture was evaporated to dryness, the residue was taken up in 100 ml of warm toluene, the so obtained suspension was filtered through glass frit (G4), and the filter cake was washed with 10 ml of toluene. This solution was evaporated to dryness, and the residue was dissolved in 50 ml of hot n-hexane. The yellow fine crystalline solid precipitated from this solution overnight at room temperature was collected and dried in vacuum. This procedure gave 16.6 g of anti-isomer of the target metallocene, containing ca. 1.1 mol of n-hexane per mol of the complex (or 1.4 g of n-hexane in the specified quantity).

The composition of the catalysts employed in the Examples is summarized in Table 1.

TABLE 1
Catalyst composition (from ICP).

| | | | | | | MC | MAO |
|---|---|---|---|---|---|---|---|
| | Al | Zr | B | Al/Zr | B/Zr | content | content |
| | wt % | wt % | wt % | molar | molar | wt % | wt % |
| Cat1 | 13.90 | 0.105 | 0.0123 | 440 | 1.0 | 1.05 | 29.9 |
| Cat2 | 14.70 | 0.073 | 0.0087 | 680 | 1.0 | 0.73 | 31.58 |
| | | | | | | MC | MAO |
| | Al | Hf | B | Al/Hf | B/Hf | content | content |
| | wt % | wt % | wt % | molar | molar | wt % | wt % |
| Cat3 | 12.80 | 0.423 | 0.0250 | 200 | 0.98 | 2.38 | 27.5 |

### Preparation of MAO-Silica Support

A steel reactor equipped with a mechanical stirrer and a filter net was flushed with nitrogen and the reactor temperature was set to 20° C. Next silica grade DM-L-303 from AGC Si-Tech Co, pre-calcined at 600° C. (5.0 kg) was added from a feeding drum followed by careful pressurizing and depressurizing with nitrogen using manual valves. Then toluene (22 kg) was added. The mixture was stirred for 15 min. Next 30 wt % solution of MAO in toluene (9.0 kg) from Lanxess was added via feed line on the top of the reactor within 70 min. The reaction mixture was then heated up to 90° C. and stirred at 90° C. for additional two hours. The slurry was allowed to settle and the mother liquor was filtered off. The catalyst was washed twice with toluene (22 kg) at 90° C., following by settling and filtration. The reactor was cooled down to 60° C. and the solid was washed with heptane (22.2 kg). Finally, this solid was dried at 60° under nitrogen flow for 2 hours and then for 5 hours under vacuum (−0.5 barg) with stirring. The resulting SiO2/MAO carrier was collected as a free-flowing white powder containing 12.2% Al by weight.

### Catalyst Preparation (Cat1)

30 wt % MAO in toluene (0.7 kg) was added into a steel nitrogen blanked reactor via a burette at 20° C. Toluene (5.4 kg) was then added under stirring. Metallocene rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]zirconium dichloride (93 g) was added from a metal cylinder followed by flushing with 1 kg toluene. The mixture was stirred for 60 minutes at 20° C. Trityl tetrakis(pentafluorophenyl)borate (91 g) was then added from a metal cylinder followed by a flush with 1 kg of toluene. The mixture was stirred for 1 h at room temperature. The resulting solution was added to a stirred cake of MAO-silica support prepared as described above over 1 hour. The cake was allowed to stay for 12 hours, followed by drying under N2 flow at 60° C. for 2 h and additionally for 5 h under vacuum (−0.5 barg) under stirring.

Dried catalyst was obtained in the form of pink, free-flowing powder containing 13.9% Al and 0.11% Zr by ICP analysis.

### Catalyst Preparation (Cat2)

Cat2 was prepared as described for Cat1, adjusting the metallocene and tritylborate amounts in order to obtain the composition reported in Table 1.

### Catalyst Preparation (Cat3)

In a nitrogen filled glovebox, a solution of MAO 0.2 mL (30% wt in toluene, AXION 1330 CA Lanxess) in dry toluene (2.3 mL) was added to an aliquot of metallocene rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]hafnium dichloride (59.3 mg, 55 μmol). This mixture was stirred for 30 minutes at room temperature. Then trityl tetrakis(pentafluorophenyl)borate (51.2 mg, 55 μmol) was added to the mixture, and the obtained solution was stirred for another 30 minutes. Next, 2.0 g of MAO treated silica prepared as described above, was placed in a glass reactor equipped with a porous glass frit. The above described solution of metallocene rac-anti-dimethylsilanediyl[2-methyl-4,8-bis(3′,5′-dimethyl phenyl)-1,5,6,7-tetrahydro-s-indacen-1-yl][2-methyl-4-(3′,5′-dimethylphenyl)-5-methoxy-6-tert-butylinden-1-yl]hafnium dichloride, trityl tetrakis(pentafluorophenyl)borate and MAO in toluene was then slowly added to the dry MAO treated silica carrier over the course of 5 minutes with gentle mixing. The resulting mixture was shaken well and allowed to stay for 1 hour. The resulting cake was dried in vacuum for 1 hour to yield 2.0 g of the catalyst as yellow free flowing powder.

### Polymerisations

### Step 1: Prepolymerisation and Bulk Homopolymerisation

A stainless-steel polymerisation reactor of total volume of 21.2 L, equipped with a ribbon stirrer, and containing 0.4 bar-g propylene was filled with 3950 g propylene. Triethylaluminum (0.80 ml of a 0.62 mol/l solution in heptane) was injected into the reactor by additional 240 g propylene. The solution was stirred at 20° C. and 250 rpm for at least 20 min. The catalyst was injected as described in the following. The desired amount of solid catalyst was loaded into a 5 ml stainless steel vial inside a glovebox, then a second 5 ml vial containing 4 ml n-heptane and pressurized with 7 bars of nitrogen was added on top of it. This dual feeder system was mounted on a port on the lid of the autoclave. Directly follows the dosing of the first aliquot of the total H2 amount via mass flow controller. Afterwards the valve between the two vials was opened and the solid catalyst was contacted with heptane under nitrogen pressure for 2 s, and then flushed into the reactor with 240 g propylene. The prepolymerisation was run for 10 min. At the end of the prepolymerisation step, the temperature was raised to 75° C. and was held constant throughout the polymerisation. As the reactor internal temperature reached 62° C., the second aliquot of H2 was added via mass flow controller. The polymerisation time was measured starting when the internal reactor temperature reached 2° C. below the set polymerisation temperature.

### Step 2: Gas Phase C3C2 Copolymerisation

After the bulk step was completed, the stirrer speed was reduced to 50 rpm and the pressure was reduced to 0.3 bar-g by venting the monomer. Then triethylaluminum (0.80 ml of a 0.62 mol/l solution in heptane) was injected into the reactor by additional 250 g propylene through a steel vial. The pressure was then again reduced down to 0.4 bar-g by venting the monomer. The stirrer speed was set to 180 rpm and the reactor temperature was set to the target temperature. Then the reactor pressure was increased to 20 bar-g by feeding a C3/C2 gas mixture (see polymerisation table) of composition defined by:

$${( \frac{{C}_{2}}{{C}_{3}} )}_{gas feed in transition} = \frac{{( \frac{{C}_{2}}{{C}_{3}} )}_{target polymer composition}}{R}$$

where C2/C3 is the weight ratio of the two monomers and R is the reactivity ratio determined independently or assumed based on similar experiments.

The temperature is kept constant by thermostat and the pressure is kept constant by feeding via mass flow controller, a C3/C2 gas mixture of composition corresponding to the target polymer composition and by thermostat, until the set time for this step has expired.

Then the reactor was cooled down (to about 30° C.) and the volatile components flashed out. After purging the reactor 3 times with N2 and one vacuum/N2 cycle, the product was taken out and dried overnight in a fume hood. 100 g of the polymer was additivated with 0.5 wt % Irganox B225 (solution in acetone) and dried overnight in a hood followed by 2 hours in a vacuum drying oven at 60° C.

Two series of heterophasic copolymers were produced under the above conditions with the zirconium catalyst (Cat1) and the Hf catalyst (Cat3), using gas phase polymerisation temperature in the range 60-90° C. (IE1-4 and CE1-4)

A third series was produced with the same zirconium catalyst (Cat1), in the gas phase temperature range 50-100° C., targeting the same rubber composition of ˜25 wt % C2, using adjusted R values as calculated from the experiments of the first series, and using variable residence times to reach ˜20 wt % gas phase split. (IE5-7 and CE5-CE6)

A fourth series has been produced with a second Zr catalyst (Cat2), in the gas phase temperature range 60-90° C., using the adjusted R values obtained from the previous experiments and a C2/C3 gas phase composition targeting ˜70 wt % C2 in the rubber, and using variable residence times to reach ˜25 wt % gas phase split (IE8-9 and CE7-8)

TABLE 2
Polymerisation examples: set-up, prepoly and transition to bulk step

| | | | | | | H₂ fed at the |
|---|---|---|---|---|---|---|
| | | | | | | end of the |
| | | | | | | transition from |
| | | Matrix | | | H₂ fed before | prepolymerisation |
| patent | | produced | Target wt % | catalyst | catalyst | to main bulk |
| example | | in liquid | C2 in gas | amount | injection | polymerisation |
| # | catalyst | monomer | phase reactor | mg | NL | NL |
| CE1 | Cat1 | hPP | C2 = 25 | 34.1 | 0.500 | 2.500 |
| CE2 | Cat1 | hPP | C2 = 25 | 50.4 | 0.500 | 2.500 |
| IE1 | Cat1 | hPP | C2 = 25 | 49.4 | 0.500 | 2.500 |
| IE2 | Cat1 | hPP | C2 = 25 | 55.7 | 0.500 | 2.500 |
| CE3 | Cat3 | hPP | C2 = 25 | 70.0 | 0.100 | 3.900 |
| CE4 | Cat3 | hPP | C2 = 25 | 76.0 | 0.100 | 3.900 |
| IE3 | Cat3 | hPP | C2 = 25 | 76.0 | 0.100 | 3.900 |
| IE4 | Cat3 | hPP | C2 = 25 | 70.0 | 0.100 | 3.900 |
| CE5 | Cat1 | hPP | C2 = 25 | 64.3 | 0.500 | 2.500 |
| CE6 | Cat1 | hPP | C2 = 25 | 60.0 | 0.500 | 2.500 |
| IE5 | Cat1 | hPP | C2 = 25 | 64.3 | 0.500 | 2.500 |
| IE6 | Cat1 | hPP | C2 = 25 | 51.4 | 0.500 | 2.500 |
| IE7 | Cat1 | hPP | C2 = 25 | 69.4 | 0.500 | 2.500 |
| CE7 | Cat2 | hPP | C2 = 70 | 61.0 | 0.100 | 1.900 |
| CE8 | Cat2 | hPP | C2 = 70 | 58.0 | 0.100 | 1.900 |
| IE8 | Cat2 | hPP | C2 = 70 | 64.0 | 0.100 | 1.900 |
| IE9 | Cat2 | hPP | C2 = 70 | 62.0 | 0.100 | 1.900 |

TABLE 3
Polymerisation examples: bulk, transition to gas phase, and gas phase steps

| | | | | C₂ fed in | C₃ fed in | | | | C₂ fed | C₃ fed |
|---|---|---|---|---|---|---|---|---|---|---|
| patent | | total | | transition | transition | | | | in GP | in GP |
| example | | H₂ | time | (MFC) | (MFC) | Pressure | time | Temperature | (MFC) | (MFC) |
| # | catalyst | NL | min | g | g | barg | min | (° C.) | g | g |
| CE1 | Cat1 | 3.0 | 40 | 266 | 335 | 20 | 90 | 60 | 18 | 54 |
| CE2 | Cat1 | 3.0 | 40 | 251 | 314 | 20 | 90 | 70 | 36 | 109 |
| IE1 | Cat1 | 3.0 | 40 | 242 | 305 | 20 | 90 | 80 | 38 | 116 |
| IE2 | Cat1 | 3.0 | 40 | 234 | 294 | 20 | 90 | 90 | 56 | 182 |
| CE3 | Cat3 | 4.0 | 40 | 280 | 279 | 20 | 73 | 60 | 51 | 160 |
| CE4 | Cat3 | 4.0 | 40 | 262 | 266 | 20 | 90 | 70 | 96 | 292 |
| IE3 | Cat3 | 4.0 | 40 | 246 | 273 | 20 | 90 | 80 | 74 | 225 |
| IE4 | Cat3 | 4.0 | 40 | 247 | 252 | 20 | 90 | 90 | 63 | 190 |
| CE5 | Cat1 | 3.0 | 40 | 282 | 330 | 20 | 161 | 50 | 49 | 148 |
| CE6 | Cat1 | 3.0 | 40 | 244 | 302 | 20 | 118 | 60 | 50 | 100 |
| IE5 | Cat1 | 3.0 | 40 | 230 | 314 | 20 | 80 | 80 | 51 | 160 |
| IE6 | Cat1 | 3.0 | 40 | 218 | 323 | 20 | 90 | 90 | 50 | 153 |
| IE7 | Cat1 | 3.0 | 40 | 209 | 339 | 20 | 51 | 100 | 50 | 152 |
| CE7 | Cat2 | 2.0 | 40 | 397 | 68 | 20 | 217 | 60 | 157 | 66 |
| CE8 | Cat2 | 2.0 | 40 | 379 | 68 | 20 | 177 | 70 | 158 | 68 |
| IE8 | Cat2 | 2.0 | 40 | 357 | 70.5 | 20 | 140 | 80 | 182 | 77 |
| IE9 | Cat2 | 2.0 | 40 | 346 | 75 | 20 | 111 | 90 | 163 | 73 |

TABLE 4
Polymerisation examples: Results

| | | Overall | MC | MFR₂ | Soluble |
|---|---|---|---|---|---|
| | Total | productivity | productivity | powder | Fraction |
| | yield | kg/g | kg/gM | g/10 | Crystex |
| Example | g | cat | C | min | wt % |
| CE1 | 378 | 11.1 | 1056 | 21.0 | 12.0 |
| CE2 | 567 | 11.3 | 1071 | 19.7 | 21.7 |
| IE1 | 631 | 12.8 | 1216 | 16.0 | 21.4 |
| IE2 | 710 | 12.8 | 1214 | 12.5 | 31.8 |
| CE3 | 1019 | 14.6 | 612 | 43.0 | 22.8 |
| CE4 | 1721 | 22.6 | 951 | 18.2 | 17.6 |
| IE3 | 1052 | 15.0 | 631 | 48.0 | 24.5 |
| IE4 | 1006 | 13.4 | 564 | 55.0 | 22.4 |
| CE5 | 720 | 11.2 | 1066 | 22.0 | 20.2 |
| CE6 | 718 | 12.0 | 1140 | 23.2 | 18.7 |
| IE5 | 826 | 12.8 | 1223 | 17.6 | 23.3 |
| IE6 | 730 | 14.2 | 1354 | 11.0 | 27.0 |
| IE7 | 915 | 13.2 | 1256 | 13.9 | 25.8 |
| CE7 | 777 | 12.7 | 1745 | 5.2 | 20.8 |
| CE8 | 758 | 13.1 | 1790 | 6.2 | 22.3 |
| IE8 | 900 | 14.1 | 1926 | 5.5 | 24.1 |
| IE9 | 845 | 13.6 | 1867 | 5.3 | 24.1 |

| | | iV | C2 | | | |
|---|---|---|---|---|---|---|
| | iV | (SF) | (SF) | M_{w} | | Tₘ |
| | (whole) | (Crystex) | (Crystex) | (SF) | M_{w}/Mₙ | (whole) |
| | (Crystex) | dl/g | wt % | g/mol | (SF) | ° C. |
| CE1 | 1.7 | 3.6 | 24.0 | 461500 | 2.8 | 155.8 |
| CE2 | 1.8 | 3.6 | 26.2 | 484000 | 2.9 | 154.8 |
| IE1 | 1.9 | 3.6 | 26.5 | 466500 | 3.2 | 154.9 |
| IE2 | 2.0 | 3.4 | 28.1 | 414500 | 3.2 | 155.4 |
| CE3 | 2.4 | 6.3 | 24.9 | 786000 | 2.5 | 159.2 |
| CE4 | 2.2 | 5.5 | 22.8 | 785000 | 2.6 | 159.6 |
| IE3 | 2.0 | 4.2 | 25.4 | 593000 | 3.4 | 158.1 |
| IE4 | 1.8 | 3.6 | 27.4 | 548000 | 4.8 | 157.5 |
| CE5 | 1.9 | 4.0 | 22.8 | 532000 | 2.7 | 155.5 |
| CE6 | 1.8 | 3.7 | 22.6 | | | 155.4 |
| IE5 | 1.9 | 3.6 | 24.4 | 519000 | 3.0 | 155.3 |
| IE6 | 2.0 | 3.6 | 26.6 | 516000 | 3.1 | |
| IE7 | 1.8 | 3.1 | 26.0 | 424000 | 3.3 | 156.2 |
| CE7 | 2.7 | 6.4 | 65.5 | 539500 | 2.2 | 153.8 |
| CE8 | 2.6 | 5.9 | 66.2 | 530694 | 2.3 | 156.7 |
| IE8 | 2.5 | 5.1 | 66.8 | 460300 | 2.6 | 154.0 |
| IE9 | 2.4 | 4.5 | 67.7 | 351700 | 3.4 | 153.9 |

### C2/C3 Reactivity Ratio and Polymer Composition Dependence on GPR Temperature

Increasing gas phase polymerisation temperature has the unexpected beneficial effect of increasing also the reactivity ratio R(C2/C3), that is increasing the reactivity of ethylene over propylene (FIG. 1, triangle data points).

C2 content in the rubber remains approximately constant with temperature (since the gas phase composition during the transition step is adjusted based on the R value, see the detailed description of experiments). The above results have been obtained targeting a rubber composition of ˜25 wt % C2. To evaluate the scope of the process we have also produced an additional series of heterophasic copolymers in which the rubber step was run (T_{GP}=60-90° C.) targeting a rubber composition of ˜70 wt % C2. The results are shown in Table 5 and FIG. 2: the results clearly show that the beneficial effect of increasing the gas phase reactor temperature on the reactivity ratio is present also at much higher C2 content.

TABLE 5
Heterophasic copolymers with Cat2, gas phase at 20 bar-g and target
C2 in copolymer 70 wt %. Residence time in gas phase has been varied
in order to obtain the same rubber content of ~25 wt %.

| | T | time | Activity GP | C2 | |
|---|---|---|---|---|---|
| | ° C. | min | kg/g_{cat}/h | mol % | R |
| CE7 | 60 | 217 | 0.8 | 75.8 | 0.36 |
| CE8 | 70 | 177 | 1.1 | 75.9 | 0.38 |
| IE8 | 80 | 140 | 1.5 | 76.5 | 0.43 |
| IE9 | 90 | 111 | 1.9 | 77.6 | 0.50 |

A higher reactivity ratio allows to produce rubbers with higher C2 content at given C2/C3 gas phase ratio and reactor pressure. As an example, FIG. 3 shows the correlation between gas phase ratio and C2 in the copolymer for R=0.36 (CE5 at 50° C.) and R=0.59 (IE7 at 100° C.).

### Rubber Molecular Weight Dependence on GPR Temperature

Typically, in the absence of added H2, the molecular weight of the polymers produced by metallocene catalysts is very sensitive to the polymerisation temperature. The drop in molecular weight with temperature is even stronger in gas phase than in condensed phase, since in the former the concentration of the monomer(s) is lower.

Surprisingly, in the case of Cat1, the rubber molecular weight at low C2 content is hardly affected by the polymerisation temperature, while in the case of the hafnium catalyst the rubber Mw decreases more strongly. However, since the value at 60° C. is a remarkably high 6.5 dL/g, even at 90° C. the rubber iV remains well above 3 dL/g. The two behaviours are shown in FIG. 4.

The influence of polymer composition on molecular weight is also quite strong, with higher C2 content giving significantly higher rubber molecular weight in the whole T_{GP} range, but also a stronger decrease with T_{GP}, as also shown in FIG. 4 for the two compositions of 25 and 67 wt %.

### Unsaturations

A feature of metallocene catalysts is the production of H2 by dehydrogenation of one chain end of the polymer chain while still linked to the active metal site. While the amount of H2 produced in propylene homopolymerisation is in practice negligible, it increases when ethylene is added. This mechanism generates internal vinylidene unsaturations in the polymer chains, that can be measured by ¹H NMR (Scheme 1).

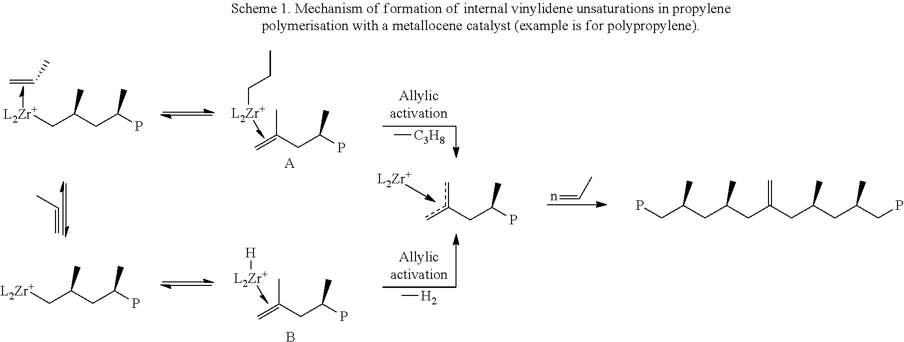

In order to have a precise measurement of these internal unsaturations, we must first distinguish between internal and terminal (end group) unsaturations. Since precise assignments of these unsaturations for C2C3 copolymers in the literature are missing, the method described in the measurement methods section enables the quantification of the internal vinylidenes of the C2C3 copolymers (soluble fraction of the heterophasic copolymers).

The proton spectra (unsaturated region) of the six C2C3 copolymers (soluble fraction) from Cat1 are stacked in FIG. 5.

The internal vinylidene content, determined by subtracting the terminal vinylidenes identified and quantified as described above, for the eight soluble fractions of the heterophasic copolymer samples from Cat1 are listed in Table 6. Their temperature dependence is shown in FIG. 6.

TABLE 6

| | | | | | | normalised |
|---|---|---|---|---|---|---|
| | | | | | | internal |
| | | | Total | Internal | Internal | vinyl- |
| | | | vinyl- | vinyl- | vinyl- | idenes |
| material | T_{GP} | C2 | idenes | idenes | idenes | mmol/kg |
| # | ° C | mol % | /10⁵ C | /10⁵ C | /chain | (rubber) |
| CE5 | 50 | 31.8 | 4.7 | 1.2 | 0.3 | 0.86 |
| CE1 | 60 | 33.0 | 6.2 | 3.1 | 1.0 | 2.21 |
| CE6 | 60 | 31.1 | 5.4 | 2.4 | 0.7 | 1.71 |
| CE2 | 70 | 33.4 | 7.2 | 4.4 | 1.6 | 3.14 |
| IE1 | 80 | 35.2 | 9.9 | 6.7 | 2.1 | 4.78 |
| IE5 | 80 | 33.5 | 9.3 | 5.6 | 1.5 | 4.00 |
| IE6 | 90 | 34.1 | 12.5 | 9.4 | 3.0 | 6.70 |
| IE7 | 100 | 35.4 | 16.3 | 11.5 | 2.4 | 8.20 |

We have also analysed one propylene homopolymer (hPP) (the matrix of the six heterophasic copolymers described above) and one ethylene-propylene random copolymer (rPP) with 1 mol % C2, produced with the same catalyst (see FIG. 7 and Table 7).

TABLE 7

| | | | total | internal |
|---|---|---|---|---|
| | T_{GP} | C2 | vinylidenes | vinylidenes |
| | ° C. | mol % | /10⁵ C | /10⁵ C |
| CE9 | 75 | 0 | 0.7 | 0.2 |
| CE10 | 75 | 1.0 | 1.5 | 0.9 |

The above results show that the internal vinylidenes produced in gas phase copolymerisation are far higher than those produced in liquid monomer(s).

Analogously, the internal vinylidene content, determined by subtracting the terminal vinylidenes, for the soluble fractions of four heterophasic copolymer samples produced at different temperatures with the Cat3 are listed in Table 8 and their temperature dependence is shown in FIG. 8 and FIG. 9.

TABLE 8

| | | | | | | normalised |
|---|---|---|---|---|---|---|
| | | | | | | internal |
| | | | total | internal | Internal | vinyl- |
| | | | vinyl- | vinyl- | vinyl- | idenes |
| | T_{GP} | C2 | idenes | idenes | idenes | mmol/kg |
| | ° C | mol % | /10⁵ C | /10⁵ C | /chain | (rubber) |
| CE3 | 60 | 34.3 | 6.2 | 4.5 | 2.7 | 3.24 |
| CE4 | 70 | 33.5 | 7.2 | 5.8 | 4.1 | 4.16 |
| IE3 | 80 | 34.5 | 11.3 | 9.3 | 4.5 | 6.60 |
| IE4 | 90 | 38.0 | 15.1 | 12.0 | 3.8 | 8.52 |

Each internal unsaturation corresponds to the generation of an equivalent of H2. This means that 1H NMR can provide a method to quantify the amount of H2 generated by the catalyst by measuring the internal unsaturations in the C2C3 copolymer.

We have also found that the amount of internal vinylidenes in the rubber phase increases with the C2 content in the rubber. The measurement based on internal unsaturations calculated from ¹H NMR are listed in Table 9 and shown in FIG. 10.

TABLE 9
Influence of copolymer composition on unsaturations

| | | | | | | normalised |
|---|---|---|---|---|---|---|
| | | | | | | internal |
| | | | total | internal | internal | vinyl- |
| | | | vinyl- | vinyl- | vinyl- | idenes |
| | T_{GP} | C2 | idenes | idenes | idenes | mmol/kg |
| | ° C. | mol % | /10⁵ C | /10⁵ C | /chain | (rubber) |
| CE11 | 70 | 19.8 | 4.4 | 1.9 | 0.8 | 1.4 |
| CE12 | 70 | 32.0 | 5.5 | 2.6 | 0.9 | 1.8 |
| CE13 | 70 | 31.5 | 5.3 | 2.5 | 0.9 | 1.8 |
| CE14 | 70 | 55.9 | 9.1 | 4.9 | 1.2 | 3.5 |
| CE15 | 70 | 54.3 | 9.1 | 54 | 1.5 | 3.8 |
| CE7 | 70 | 75.9 | 11.3 | 7.5 | 2.0 | 5.4 |

The above finding that the number of internal vinylidenes in the rubber phase increases with the C2 content in the rubber, suggests that, by increasing both the polymerisation temperature and the C2 content in the gas phase comonomer feed, one may obtain rubbers with even higher content of internal vinylidene unsaturation. To confirm this hypothesis, we have analysed the soluble fraction of the heterophasic copolymers produced with Cat2 at different gas phase reactor temperatures (T range 60-90° C.) while keeping the C2 content in the rubber constant at ˜67 wt %. The results are listed in Table 10 and shown in FIG. 9.

TABLE 10
Heterophasic copolymers with Cat2, gas phase at 20 bar-g and C2
in copolymer ~67 wt %. Residence time in gas phase has been
varied in order to obtain the same rubber content of ~25 wt %.

| | Gas phase conditions and analysis of soluble fraction | | | | | | |
|---|---|---|---|---|---|---|---|
| | | | | | | | normalised |
| | | | | Total | Internal | Internal | internal |
| | | | | vinyl- | vinyl- | vinyl- | vinyl- |
| | | | | idenes | idenes | idenes | idenes |
| | T_{GP} | C2 | | mol/ | mol/ | mol/ | mmol/kg |
| | ° C | mol % | R | 10⁵ C | 10⁵ C | chain | (rubber) |
| CE7 | 60 | 75.8 | 0.36 | 8.5 | 5.1 | 1.5 | 3.6 |
| CE8 | 70 | 75.9 | 0.38 | 11.3 | 7.5 | 2.0 | 5.4 |
| IE8 | 80 | 76.5 | 0.43 | 14.7 | 9.8 | 2.0 | 7.0 |
| IE9 | 90 | 77.6 | 0.50 | 18.7 | 13.8 | 2.8 | 9.8 |

### Advantages of a Higher Number of Internal Unsaturations

The presence of internal unsaturations is bound to make the rubber phase of these heterophasic copolymers more easily cross-linkable, generating upon reactive modification TPV-like materials and further improving the elastic and impact properties of the heterophasic copolymers.

Therefore, the higher the amount of unsaturations, the higher the chance of crosslinking vs visbreaking.

In addition, reaction of the internal vinylidenes with peroxides can generate allyl radicals that in turn can be the initiators for radical polymerisation or functionalisation reactions.

Methods for functionalising a polymer vinyl unsaturations are well known in the literature, see for example: Macromolecules 2005, vol. 38, issue 25, pp. 10373-10378; J. Appl. Polym. Sci. 1995, vol. 56, issue 5, pp. 533-543.

### Long Chain Branching (LCB)

The method for the detection and quantification of LCB in the amorphous phase of heterophasic copolymers from metallocene catalysts is described in the measurement methods section: the more the g′ values measured by GPC are lower than 1 (g′=1 for a linear polymer), the more LCB there are in the polymer.

The calculated g′ values are listed in Table 11 and their dependence on T_{GP} is shown in FIG. 11 for catalysts Cat1 and Cat3.

TABLE 11a

| | | C2, | C2, | g′(85-100) | LCB | |
|---|---|---|---|---|---|---|
| | T_{GP} | wt % | mol % | (GPC- | per | LCB/ |
| | ° C | (NMR) | (NMR) | VISC-LS) | chain | 1000TC |
| CE5 | 50 | 23.7 | 31.8 | 0.80 | 5.09 | 0.073 |
| CE1 | 60 | 24.7 | 33.0 | 0.79 | 5.16 | 0.079 |
| CE6 | 60 | 23.2 | 33.0 | 0.78 | 5.54 | 0.078 |
| CE2 | 70 | 25.0 | 33.4 | 0.75 | 6.46 | 0.091 |
| IE1 | 80 | 26.6 | 35.2 | 0.72 | 7.53 | 0.105 |
| IE5 | 80 | | 33.5 | 0.72 | 7.72 | 0.112 |
| IE6 | 90 | 25.7 | 34.1 | 0.69 | 8.77 | 0.118 |
| IE7 | 100 | 26.8 | 35.4 | 0.68 | 9.44 | 0.156 |

TABLE 11b

| | | C2, | C2, | g′(85-100) | LCB | |
|---|---|---|---|---|---|---|
| | T_{GP} | wt % | mol % | (GPC- | per | LCB/ |
| | ° C | NMR | (NMR) | VISC-LS) | chain | 1000TC |
| CE3 | 60 | 25.8 | 34.3 | 0.97 | 0.83 | 0.008 |
| CE4 | 70 | 25.2 | 33.5 | 0.93 | 1.88 | 0.018 |
| IE3 | 80 | 26.0 | 34.5 | 0.86 | 3.41 | 0.036 |
| IE4 | 90 | 29.0 | 38.0 | 0.73 | 7.14 | 0.071 |

It is apparent that the number of long chain branches increases by increasing the temperature in the gas phase reactor for both catalysts. The Zr catalyst produces more LCB than the Hf catalyst.

As we did for unsaturations, we studied the LCB content also for the propylene homopolymer (hPP) and the ethylene-propylene random copolymer (rPP) produced with Cat1 in liquid monomers at 75° C. The results are shown in Table 12.

TABLE 12
LCB estimation of hPP and a rPP

| | C2, | C2, | g′(85-100) | | |
|---|---|---|---|---|---|
| | wt % | mol % | (GPC-VISC- | LCB | LCB/ |
| | (NMR) | (NMR) | LS) | per chain | 1000TC |
| CE10 | 0.7 | 1.0 | 0.99 | 0.13 | 0.004 |
| CE9 | 0.0 | 0.0 | 0.99 | 0.37 | 0.018 |

As one can see, these two materials are substantially linear.

In order to better define the correlation between C2 content and LCB, two sets of heterophasic copolymers have been produced with Cat2: the first set has been produced by keeping the gas phase reactor temperature constant at 70° C. and varying the C2 content in the rubber phase (14-70 wt %), while the second set has been produced by keeping the C2 content in the rubber phase constant at ˜70 wt % C2 and varying the gas phase reactor temperature (60-90° C.) The results are listed in Table 13 and Table 14. The dependence on gas phase temperature at ˜70 wt % C2 is shown in FIG. 12.

TABLE 13
Influence of C2 content on unsaturations and LCB (T_{GP} = 70° C.)

| | | | | g′(85-100) | | |
|---|---|---|---|---|---|---|
| | C2 | C2 | | (GPC- | LCB | LCB |
| | mo1% | wt % | T | VISC-LS) | /chain | /1000TC |
| CE11 | 19.8 | 14.1 | 70 | 0.8 | 5.07 | 0.057 |
| CE13 | 31.5 | 23.5 | 70 | 0.75 | 6.57 | 0.084 |
| CE14 | 55.9 | 45.8 | 70 | 0.74 | 6.81 | 0.112 |
| CE7 | 75.9 | 67.7 | 70 | 0.85 | 3.77 | 0.057 |

TABLE 14
Influence of T_{GP} on unsaturations and LCB (C2 ~70 wt %)

| | | | | g'(85-100) | | |
|---|---|---|---|---|---|---|
| | mol % | wt % | | (GPC- | LCB | LCB |
| Sample | C2 | C2 | T | VISC-LS) | /chain | /1000TC |
| CE7 | 75.8 | 67.6 | 60 | 0.9 | 2.47 | 0.038 |
| CE8 | 75.9 | 67.7 | 70 | 0.85 | 3.77 | 0.057 |
| IE8 | 76.5 | 68.5 | 80 | 0.81 | 4.67 | 0.076 |
| IE9 | 77.6 | 69.8 | 90 | 0.79 | 5.37 | 0.106 |

It must be noted that again, increasing the gas phase temperature increases the LCB content.

1. A heterophasic polypropylene resin comprising a polypropylene matrix phase (A) and an ethylene-propylene copolymer phase (B) dispersed within said polypropylene matrix phase, wherein the ethylene-propylene copolymer phase (B) is an amorphous ethylene-propylene copolymer with an intrinsic viscosity (iV) measured in decalin at 135° C. of at least 2.5 and having at least one of the following properties;
(i) more than 1 internal vinylidene unsaturation per chain measured as described in the Measurement methods section Quantification of Internal Vinylidene Unsaturations; and
(ii) more than 2 long chain branches per chain measured as described in the Measurement methods section Branching Calculation g′(85-100 cum).

2. A heterophasic polypropylene resin as claimed in claim 1, wherein said copolymer has both properties (i) and (ii).

3. A heterophasic polypropylene resin as claimed in claim 1 or 2, wherein said copolymer has an ethylene content of at least 15 wt %, preferably at least 20 wt %, more preferably at least 21 wt %, even more preferably at least 22 wt %, such as at least 24 wt % relative to the total weight of the copolymer.

4. A heterophasic polypropylene resin as claimed in any of claims 1 to 3, wherein said copolymer has an iV measured in decalin at 135° C. of at least 3.0.

5. A heterophasic polypropylene resin as claimed in any of claims 1 to 4, wherein the polypropylene matrix phase (A) is at least partially crystalline.

6. A heterophasic polypropylene resin as claimed in any one of claims 1 to 5, said resin comprising at least 40 wt %, preferably 45 to 90 wt %, more preferably 50 to 85 wt %, of said polypropylene matrix phase (A), relative to the total weight of the heterophasic polypropylene resin.

7. A heterophasic polypropylene resin as claimed in claim 5 or 6, said resin comprising at least 10 wt %, preferably 10 to 55 wt %, more preferably 15 to 50 wt %, of said ethylene-propylene copolymer phase (B), relative to the total weight of the heterophasic polypropylene resin.

8. A heterophasic polypropylene resin as claimed in any of claims 5 to 7, wherein said resin has an MFR₂ (measured according to ISO1133 at 230° C. with 2.16 kg load) of 0.1 to 200 g/10 min, more preferably 1.0 to 100 g/10 min, such as 2.0 to 50 g/10 min.

9. A process for the preparation of a heterophasic polypropylene resin in a multistage polymerisation process in the presence of a metallocene catalyst, said process comprising:
(I) in a first polymerisation step, polymerising propylene and optionally at least one C2-10 alpha olefin comonomer; and subsequently
(II) in a second polymerisation step, polymerising propylene, ethylene and optionally at least one C3-10 alpha olefin comonomer, in the presence of the catalyst and polymer from step (I);
wherein said metallocene catalyst comprises a metallocene complex of Formula I 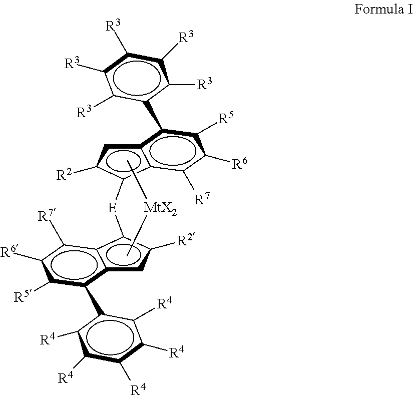
wherein Mt is Zr or Hf;
each X is a sigma-ligand;
E is a —CR¹₂—, —CR¹₂—CR¹₂—, —CR¹₂—SiR¹₂—, —SiR¹₂— or —SiR¹₂—SiR¹₂— group chemically linking the two cyclopentadienyl ligands; The R¹ groups, which can be the same or can be different, are hydrogen or C₁₋₂₀ hydrocarbyl groups, optionally containing up to 2 silicon, oxygen, sulphur or nitrogen atoms, and optionally two R¹ groups can be part of a C₄-C₈ ring,
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY group wherein Y is a C₁₋₁₀ hydrocarbyl group, and optionally two adjacent R³ or R⁴ groups can be part of a ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷=H, then both R⁵, R⁶≠H, and when R^{7′}=H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen; and
wherein step (II) takes place in at least one gas phase reactor operating at a temperature of at least 80° C.

10. A process as claimed in claim 9, wherein said at least one gas phase reactor is operated at a temperature of 85 to 120° C., such as 90 to 100° C.

11. A process as claimed in claim 9 or 10, wherein the heterophasic polypropylene resin is as defined in any one of claims 5 to 8.

12. A process as claimed in any of claims 9 to 11, wherein said metallocene complex has a structure described by Formula II: 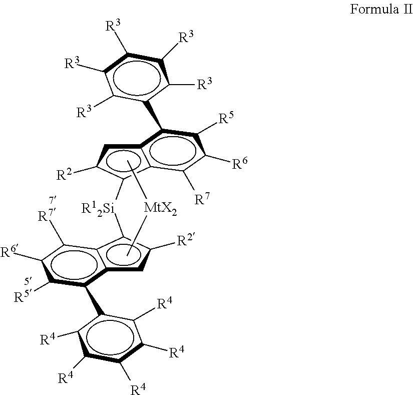
wherein Mt is Zr or Hf;
X, which can be the same or different from each other, are halogen, hydrogen, C₁₋₂₀ hydrocarbyl groups, optionally containing up to 2 silicon, oxygen, sulphur or nitrogen atoms, or OY or NY₂ groups wherein Y is a C₁₋₁₀ hydrocarbyl group optionally containing up to 2 silicon atoms;
the two R¹ groups on silicon, which can be the same or different from each other, are hydrogen or C₁₋₂₀ hydrocarbyl groups, optionally containing up to 2 silicon, oxygen, sulphur or nitrogen atoms, and are preferably C₁₋₈ hydrocarbyl groups: most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl:
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY or NY₂ group wherein Y is a C₁₋₁₀ hydrocarbyl group, and can be —CH═, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand; and
R⁷ and R^{7′}, same or different from each other, are H or an OY group or a C₁₋₂₀ hydrocarbyl group optionally containing up to two silicon, oxygen, sulphur or nitrogen atoms, with the proviso that when R⁷=H, then both R⁵, R⁶≠H, and when R^{7′}=H, then both R^{5′}, R^{6′}≠H, and with the additional proviso that R⁵ and R⁶ can be hydrogen only when R⁷ is different from hydrogen and that R^{5′} and R^{6′} can be hydrogen only when R^{7′} is different from hydrogen;
or Formula III 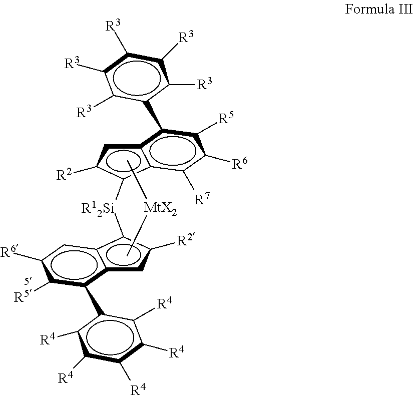
wherein Mt is Zr or Hf;
X, which can be the same or different from each other, are halogen, hydrogen, C₁₋₆ hydrocarbyl groups, or OY or NY₂ groups wherein Y is a C₁₋₆ hydrocarbyl group optionally containing 1 silicon atom;
the two R¹ groups on silicon, which can be the same or different from each other, are hydrogen or C₁₋₈ hydrocarbyl groups, optionally containing up to 2 silicon, oxygen, sulphur or nitrogen atoms, and are preferably C₁₋₈ hydrocarbyl groups; most preferably one R¹ is hydrogen, methyl, ethyl, n-propyl or i-propyl, and the other R¹ is selected from methyl, ethyl, n-propyl, i-propyl, n-butyl, i-butyl, pentyl, cyclopentyl, hexyl, cyclohexyl and phenyl;
R² and R^{2′} are the same or different from each other, and are a —CH₂R group, with R being H or a linear or branched C₁₋₆ alkyl group, C₃₋₈ cycloalkyl group, C₆₋₁₀ aryl group;
preferably, R² and R^{2′} are the same and are linear or branched C₁₋₆ alkyl groups;
each R³ and R⁴ are independently the same or can be different and are hydrogen, a linear or branched C₁-C₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded;
each R⁵, R^{5′}, R⁶ and R^{6′} are independently hydrogen or a C₁₋₂₀ hydrocarbyl group, optionally containing up to 2 silicon, oxygen, sulphur or nitrogen atoms, or an OY group wherein Y is a C₁₋₁₀ hydrocarbyl group, and can be —CH—, —CY═, —CH₂—, —CHY— or —CY₂— groups that are part of a cyclic structure of 4 to 7 atoms, including the carbon atoms at positions 5 and 6 and/or 5′ and 6′ of the corresponding indenyl ligand;
R⁷ is H or an OY group or a C₁₋₂₀ hydrocarbyl group optionally containing up to two silicon, oxygen, sulphur or nitrogen atoms, with the proviso that when R⁷=H, then both R⁵, R⁶≠H, and with the additional proviso that R⁵ and R⁶ can be hydrogen only when R⁷ is different from hydrogen.

13. A process as claimed in any of claims 9 to 12, wherein said metallocene complex has a structure described by Formula XIII: 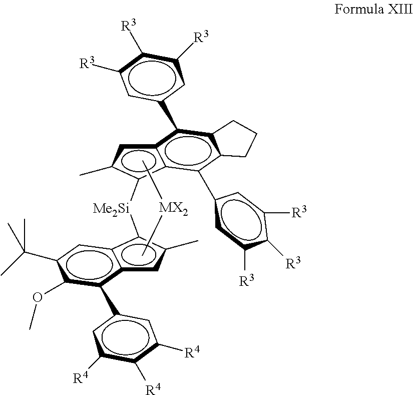
wherein M is Zr or Hf;
X, which can be the same or different from each other, are halogen, C₁₋₆ hydrocarbyl groups, or OY or NY₂ groups wherein Y is a C₁₋₁₀ hydrocarbyl group optionally containing up to 2 silicon atoms;
each R³ and R⁴ are independently the same or can be different and are hydrogen, a linear or branched C₁₋₆ alkyl group, a C₇₋₂₀ arylalkyl, a C₇₋₂₀ alkylaryl group, C₆₋₂₀ aryl group, an OY or NY₂ group wherein Y is a C₁₋₁₀ hydrocarbyl group, and optionally two adjacent R³ or R⁴ groups can be part of a 4-7 atom ring including the phenyl carbons to which they are bonded.

14. A heterophasic polypropylene resin obtained or obtainable by a process as defined in any of claims 9 to 13.

15. Use of an amorphous ethylene propylene copolymer as defined in any of claims 1 to 4, or a heterophasic polypropylene resin as defined in any of claim 5 to 8 or 14 in the manufacture of an article, e.g. a flexible tube, pipe, profile, cable insulation, sheet or film.
